(19) United States
(12) Patent Application Publication
(10) Pub. No.: US 2022/0276465 A1
(43) Pub. Date: Sep. 1, 2022

(54) IMAGING LENS

(71) Applicant: KANTATSU CO., LTD., Tokyo (JP)

(72) Inventor: Masaki YAMAZAKI, Tokyo (JP)

(21) Appl. No.: 17/394,030

(22) Filed: Aug. 4, 2021

(30) Foreign Application Priority Data
Aug. 4, 2020 (JP) 2020-132098

(51) Int. Cl. G02B 9/64; G02B 13/00

(52) U.S. Cl. CPC G02B 9/64; G02B 13/0045

(57) ABSTRACT

An imaging lens includes: arranged in order from an object side to an image side, a first lens L1 having positive refractive power; a second lens L2 having negative refractive power; a third lens L3 having positive refractive power; a fourth lens L4 having negative refractive power; a fifth lens L5; a sixth lens L6; a seventh lens L7; and an eighth lens L8 having negative refractive power, wherein the eighth lens has an aspheric image-side surface having at least one inflection point, and a conditional expression below is satisfied:

−12.0<f4/f<−3.0
where
f: a focal length of entire optical system of the imaging lens, and
f4: a focal length of the fourth lens.

The present invention relates to an imaging lens for forming an image of an object on an image sensor, such as a CCD sensor and a CMOS sensor.

With the development of loT (Internet of Things) technology, portable information devices, such as smartphones and cellular phones, as well as many products and devices, such as video game consoles, home appliances, and automobiles, are connected to networks, and various types of information are shared between these “Things”. In the loT environment, various services are allowed to be provided using image information from cameras built in the “Things”. The image information transmitted through networks continuously increases every year and such a camera is expected to have high resolution.

To obtain a high-resolution distinctive image, aberrations in an imaging lens built in the camera have to be satisfactorily corrected. A lens configuration including eight lenses has, due to the large number of lenses composing the imaging lens, a high degree of freedom in design and thus allows satisfactory correction of aberrations. Patent Document 1 discloses an imaging lens having such an eight-lens configuration.

The imaging lens described in Patent Document 1 includes: a first lens having positive refractive power; a second lens having negative refractive power; a third lens having positive refractive power; a fourth lens; a fifth lens; a sixth lens; a seventh lens; and an eighth lens having negative refractive power. In the imaging lens, the refractive power of the first lens is less than the refractive power of the entire optical system of the imaging lens in a certain range and the third lens has a shape limited to a specific shape defined by a curvature radius. In addition, the second lens has a thickness in a certain range relative to the distance between the second lens and the third lens to achieve satisfactory correction of aberrations.

Patent Document 1: Chinese Patent Application Publication No. 111007631

The above imaging lens described in Patent Document 1 allows relatively satisfactory correction of aberrations while providing a wide field of view. However, the resolution expected from the imaging lens increases every year, and considering adaptation of high resolution, the lens configuration described in Patent Document 1 causes insufficient correction of aberrations. Furthermore, in recent years, from the perspective of photographing in an environment of small light quantity or suppression of blurring of the object during photographing, a low F-number of the imaging lens is strongly requested.

It is an object of the present invention to provide an imaging lens which is compact, has a low F-number, and is capable of satisfactorily correcting aberrations.

An imaging lens according to the present invention for forming an image of an object on an image sensor includes: in order from an object side to an image side, a first lens having positive refractive power; a second lens having negative refractive power; a third lens having positive refractive power; a fourth lens having negative refractive power; a fifth lens; a sixth lens; a seventh lens; and an eighth lens having negative refractive power. The eighth lens has an aspheric image-side surface having at least one inflection point.

In the imaging lens according to the present invention, the second lens having negative refractive power is arranged on the image plane side of the first lens having positive refractive power. This allows satisfactory correction of chromatic aberration while preferably reducing the profile of the imaging lens. In addition, since the third lens has positive refractive power, the first through third lenses are arranged in order with positive, negative, and positive refractive power, and it is thus possible to satisfactorily correct chromatic aberrations in a wide range of wavelengths.

The eighth lens with the image-side surface formed in an aspheric shape having at least one inflection point allows satisfactory correction of field curvature and distortion at an image periphery while securing a back focus. The shape of the eighth lens also allows satisfactory correction of the aberrations in the paraxial and peripheral regions while controlling an incident angle of a ray of light emitted from the imaging lens into the image plane of the image sensor to be within the range of chief ray angle (CRA).

It should be noted that a “lens” in the present invention refers to an optical element having refractive power. Accordingly, the term “lens” used herein does not include optical elements such as a prism to change a direction of light travel and a flat filter. These optical elements may be arranged in front of or behind the imaging lens or between respective lenses, as necessary.

According to the imaging lens having the above-described configuration, it is preferable that the fourth lens has negative refractive power.

When the fourth lens having the negative refractive power is arranged on the image plane side of the third lens, the third lens and the fourth lens are arranged in order with positive and negative refractive power, and it is thus possible to precisely correct chromatic aberration strongly desired for such an imaging lens with higher resolution.

According to the imaging lens having the above-described configuration, it is preferable that the following conditional expression (1) is satisfied:

3.5<|R1r/R1f|<8.5 (1)
where
R1f: a curvature radius of an object-side surface of the first lens, and
R1r: a curvature radius of an image-side surface of the first lens.

By satisfying the conditional expression (1), spherical aberration can be satisfactorily corrected.

According to the imaging lens having the above-described configuration, it is preferable that the following conditional expression (2) is satisfied:

1.35<f3/f<4.50 (2)
where
f: a focal length of entire optical system of the imaging lens, and
f3: a focal length of the third lens.

By satisfying the conditional expression (2), the spherical aberration, coma aberration, astigmatism, and field curvature can be satisfactorily corrected in a well-balanced manner.

According to the imaging lens having the above-described configuration, it is preferable that the following conditional expression (3) is satisfied:

1.20<f3/f1<4.50 (3)
where
f1: a focal length of the first lens, and
f3: a focal length of the third lens.

By satisfying the conditional expression (3), the coma aberration can be satisfactorily corrected.

According to the imaging lens having the above-described configuration, it is preferable that the following conditional expression (4) is satisfied:

−12.00<f4/f<−3.00 (4)
where
f: a focal length of entire optical system of the imaging lens, and
f4: a focal length of the fourth lens.

By satisfying the conditional expression (4), the field curvature can be satisfactorily corrected.

According to the imaging lens having the above-described configuration, it is preferable that the following conditional expression (5) is satisfied:

−5.50<f4/f3<−0.80 (5)
where
f3: a focal length of the third lens, and
f4: a focal length of the fourth lens.

By satisfying the conditional expression (5), the field curvature can be satisfactorily corrected.

According to the imaging lens having the above-described configuration, it is preferable that the following conditional expression (6) is satisfied:

−8.00<f234/f<−2.00 (6)
where
f: a focal length of entire optical system of the imaging lens, and
f234: a composite focal length of the second lens, the third lens, and the fourth lens.

By satisfying the conditional expression (6), the spherical aberration and the coma aberration can be satisfactorily corrected in a well-balanced manner.

According to the imaging lens having the above-described configuration, it is preferable that the following conditional expression (7) is satisfied:

2.0<D45/D56<4.0 (7)
where
D45: a distance along the optical axis between the fourth lens and the fifth lens, and
D56: a distance along the optical axis between the fifth lens and the sixth lens.

By satisfying the conditional expression (7), the spherical aberration, the coma aberration, the astigmatism, and the field curvature can be satisfactorily corrected in a well-balanced manner.

According to the imaging lens having the above-described configuration, it is preferable that the sixth lens has an object-side surface being concave.

When the sixth lens has an object-side surface being concave, the astigmatism, the field curvature, and distortion can be satisfactorily corrected.

According to the imaging lens having the above-described configuration, it is preferable that the sixth lens is formed in a meniscus shape in a paraxial region, and the following conditional expression (8) is satisfied:

1.0<R6f/R6r<30.0 (8)
where
R6f: a curvature radius of an object-side surface of the sixth lens, and
R6r: a curvature radius of an image-side surface of the sixth lens.

By satisfying the conditional expression (8), reduction in a profile of the imaging lens is achieved, and the distortion and chromatic aberration of magnification can be satisfactorily corrected.

According to the imaging lens having the above-described configuration, it is preferable that the following conditional expression (9) is satisfied:

−2.50<f2/f6<−0.30 (9)
where
f2: a focal length of the second lens, and
f6: a focal length of the sixth lens.

By satisfying the conditional expression (9), reduction in the profile of the imaging lens is achieved, and the spherical aberration, the field curvature, and the chromatic aberration of magnification can be satisfactorily corrected in a well-balanced manner.

According to the imaging lens having the above-described configuration, it is preferable that the following conditional expression (10) is satisfied:

0.50<f3/f6<2.50 (10)
where
f3: a focal length of the third lens, and
f6: a focal length of the sixth lens.

By satisfying the conditional expression (10), reduction in the profile of the imaging lens is achieved, and the spherical aberration, the field curvature, and the chromatic aberration of magnification can be satisfactorily corrected in a well-balanced manner.

According to the imaging lens having the above-described configuration, it is preferable that the following conditional expression (11) is satisfied:

−15.00<f7/f<−3.50 (11)
where
f: a focal length of entire optical system of the imaging lens, and
f7: a focal length of the seventh lens.

By satisfying the conditional expression (11), the coma aberration and the chromatic aberration of magnification can be satisfactorily corrected.

According to the imaging lens having the above-described configuration, it is preferable that the following conditional expression (12) is satisfied:

0.50<f67/f<4.00 (12)
where
f: a focal length of entire optical system of the imaging lens, and
f67: a composite focal length of the sixth lens and the seventh lens.

By satisfying the conditional expression (12), the spherical aberration and the coma aberration can be satisfactorily corrected.

According to the imaging lens having the above-described configuration, it is preferable that the following conditional expression (13) is satisfied:

1.0<R8f/R8r<100.0 (13)
where
R8f: a curvature radius of an object-side surface of the eighth lens, and
R8r: a curvature radius of an image-side surface of the eighth lens.

By satisfying the conditional expression (13), reduction in the profile of the imaging lens is achieved, and the spherical aberration, the field curvature, and the chromatic aberration of magnification can be satisfactorily corrected in a well-balanced manner.

According to the imaging lens having the above-described configuration, to achieve a lower F number, it is preferable that the following conditional expression (13a) is satisfied:

20.0<R8f/R8r<100.0. (13a)

According to the imaging lens having the above-described configuration, it is preferable that the following conditional expression (14) is satisfied:

0.05<f8/f7<0.80 (14)
where
f7: a focal length of the seventh lens, and
f8: a focal length of the eighth lens.

By satisfying the conditional expression (14), the spherical aberration, the coma aberration, the astigmatism, the field curvature, and the chromatic aberration of magnification can be satisfactorily corrected in a well-balanced manner.

According to the imaging lens having the above-described configuration, it is preferable that the following conditional expression (15) is satisfied:

0.03<D78/f<0.15 (15)
where
f: a focal length of entire optical system of the imaging lens, and
D78: a distance along the optical axis between the seventh lens and the eighth lens.

By satisfying the conditional expression (15), the spherical aberration, the coma aberration, the astigmatism, and the field curvature can be satisfactorily corrected in a well-balanced manner. Additionally, a back focus can be secured and miniaturization of the imaging lens can be appropriately achieved.

According to the imaging lens having the above-described configuration, to more satisfactorily correct axial chromatic aberration and the chromatic aberration of magnification, it is preferable that the following conditional expressions (16) and (17) are satisfied:

35<vd3 (16)

35<vd4 (17)
where
vd3: an abbe number at d-ray of the third lens, and
vd4: an abbe number at d-ray of the fourth lens.

According to the imaging lens having the above-described configuration, it is further preferable that the following conditional expressions (16a) and (17a) are satisfied:

35<vd3<90 (16a)

35<vd4<90. (17a)

According to the imaging lens having the above-described configuration, to satisfactorily correct the chromatic aberration of magnification, it is preferable that the following conditional expressions (18) and (19) are satisfied:

vd7<35 (18)

35<vd8 (19)
where
vd7: an abbe number at d-ray of the seventh lens, and
vd8: an abbe number at d-ray of the eighth lens.

According to the imaging lens having the above-described configuration, it is further preferable that the following conditional expressions (18a) and (19a) are satisfied:

15<vd7<35 (18a)

35<vd8<90. (19a)

It is preferable that, in the imaging lens of the present invention, the following conditional expression (20) is satisfied:

TL/f<1.3 (20)
where
f: a focal length of entire optical system of the imaging lens, and
TL: a distance along the optical axis from an object-side surface of the first lens to an image plane.

By satisfying the conditional expression (20), miniaturization of the imaging lens can be achieved.

It should be noted that inserts, such as an infrared cut filter and a cover glass, are generally arranged between the imaging lens and the image plane while an air equivalent length is used herein as a distance along the optical axis of these inserts.

It is preferable that, in the imaging lens of the present invention, each of the first to the eighth lenses is arranged with an air gap. Arrangement of each lens with an air gap allows the imaging lens of the present invention to have a lens configuration where not even one cemented lens is contained. Such a lens configuration allows all the eight lenses composing the imaging lens to be formed from plastic materials and thus reduction in the production cost of the imaging lens.

It is preferable that, in the imaging lens of the present invention, both surfaces of each of the first to the eighth lenses are formed as aspheric surfaces. Formation of both surfaces of each lens as aspheric surfaces allows more satisfactory correction of aberrations from the paraxial region to the lens periphery. Especially, aberrations at the lens periphery can be satisfactorily corrected.

According to the imaging lens having the above-described configuration, it is preferable that at least two surfaces of the seventh lens and the eighth lens are formed as aspheric surfaces provided with at least one inflection point. In this context, when one more aspheric lens surface having at least one inflection point is provided in addition to the image-side surface of the eighth lens, an incident angle of a ray of light emitted from the imaging lens into the image plane can be more preferably controlled within the range of CRA, and aberrations at the image periphery can be more satisfactorily corrected.

According to the imaging lens of the present invention, when a field of view is 2ω, it is preferable that a conditional expression, 65°≤2ω is satisfied. When the conditional expression is satisfied, a wider field of view of the imaging lens can be achieved and miniaturization of the imaging lens and the wide field of view can be preferably co-achieved.

The surface shapes of each lens herein are specified using signs of the radii of curvature. Whether the curvature radius is positive or negative is determined in accordance with a general definition, that is, given that the traveling direction of the light is positive, the curvature radius is considered to be positive if the center of the curvature radius is on the image plane side viewed from the lens surface and the curvature radius is considered to be negative if the center is on the object side. Accordingly, an “object-side surface with a positive curvature radius” refers to a convex object-side surface, and an “object-side surface with a negative curvature radius” refers to a concave object-side surface. In addition, an “image-side surface with a positive curvature radius” refers to a concave image-side surface, and an “image-side surface with a negative curvature radius” refers to a convex image-side surface. It should be noted that the curvature radius herein refers to a paraxial curvature radius and may not be consistent with outlines of the lenses in their sectional views.

According to the imaging lens of the present invention, it is achievable to provide an imaging lens having a small F number, which is especially suitable for mounting in a small-sized camera, while having high resolution with proper correction of aberrations.

### BRIEF DESCRIPTION OF THE DRAWINGS

FIG. 1 is a sectional view illustrating a schematic configuration of an imaging lens according to Example 1 of the present invention;

FIG. 2 is an aberration diagram illustrating spherical aberration, astigmatism, and distortion of the imaging lens in FIG. 1;

FIG. 3 is a sectional view illustrating a schematic configuration of an imaging lens according to Example 2 of the present invention;

FIG. 4 is an aberration diagram illustrating spherical aberration, astigmatism, and distortion of the imaging lens in FIG. 3;

FIG. 5 is a sectional view illustrating a schematic configuration of an imaging lens according to Example 3 of the present invention;

FIG. 6 is an aberration diagram illustrating spherical aberration, astigmatism, and distortion of the imaging lens in FIG. 5;

FIG. 7 is a sectional view illustrating a schematic configuration of an imaging lens according to Example 4 of the present invention;

FIG. 8 is an aberration diagram illustrating spherical aberration, astigmatism, and distortion of the imaging lens in FIG. 7;

FIG. 9 is a sectional view illustrating a schematic configuration of an imaging lens according to Example 5 of the present invention;

FIG. 10 is an aberration diagram illustrating spherical aberration, astigmatism, and distortion of the imaging lens in FIG. 9;

FIG. 11 is a sectional view illustrating a schematic configuration of an imaging lens according to Example 6 of the present invention;

FIG. 12 is an aberration diagram illustrating spherical aberration, astigmatism, and distortion of the imaging lens in FIG. 11;

FIG. 13 is a sectional view illustrating a schematic configuration of an imaging lens according to Example 7 of the present invention;

FIG. 14 is an aberration diagram illustrating spherical aberration, astigmatism, and distortion of the imaging lens in FIG. 13;

FIG. 15 is a sectional view illustrating a schematic configuration of an imaging lens according to Example 8 of the present invention;

FIG. 16 is an aberration diagram illustrating spherical aberration, astigmatism, and distortion of the imaging lens in FIG. 15;

FIG. 17 is a sectional view illustrating a schematic configuration of an imaging lens according to Example 9 of the present invention;

FIG. 18 is an aberration diagram illustrating spherical aberration, astigmatism, and distortion of the imaging lens in FIG. 17;

FIG. 19 is a sectional view illustrating a schematic configuration of an imaging lens according to Example 10 of the present invention;

FIG. 20 is an aberration diagram illustrating spherical aberration, astigmatism, and distortion of the imaging lens in FIG. 19;

FIG. 21 is a sectional view illustrating a schematic configuration of an imaging lens according to Example 11 of the present invention;

FIG. 22 is an aberration diagram illustrating spherical aberration, astigmatism, and distortion of the imaging lens in FIG. 21;

FIG. 23 is a sectional view illustrating a schematic configuration of an imaging lens according to Example 12 of the present invention; and

FIG. 24 is an aberration diagram illustrating spherical aberration, astigmatism, and distortion of the imaging lens in FIG. 23.

### DETAILED DESCRIPTION OF EMBODIMENTS

### (First Embodiment)

Referring to the accompanying drawings, an embodiment of the present invention will be described in detail below. The imaging lens according to the present embodiment has a lens configuration especially suitable for a low F number.

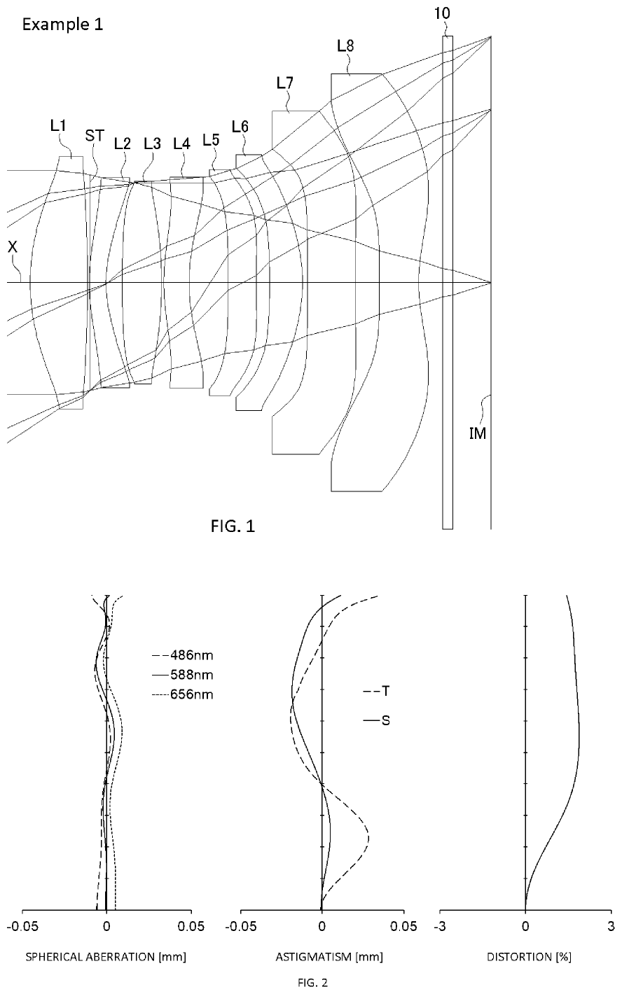

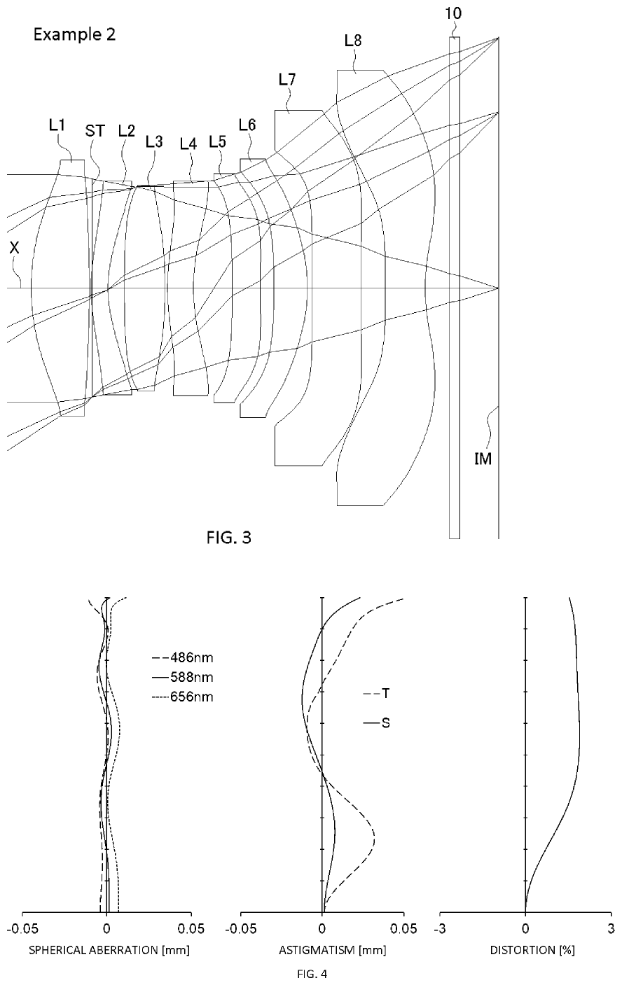

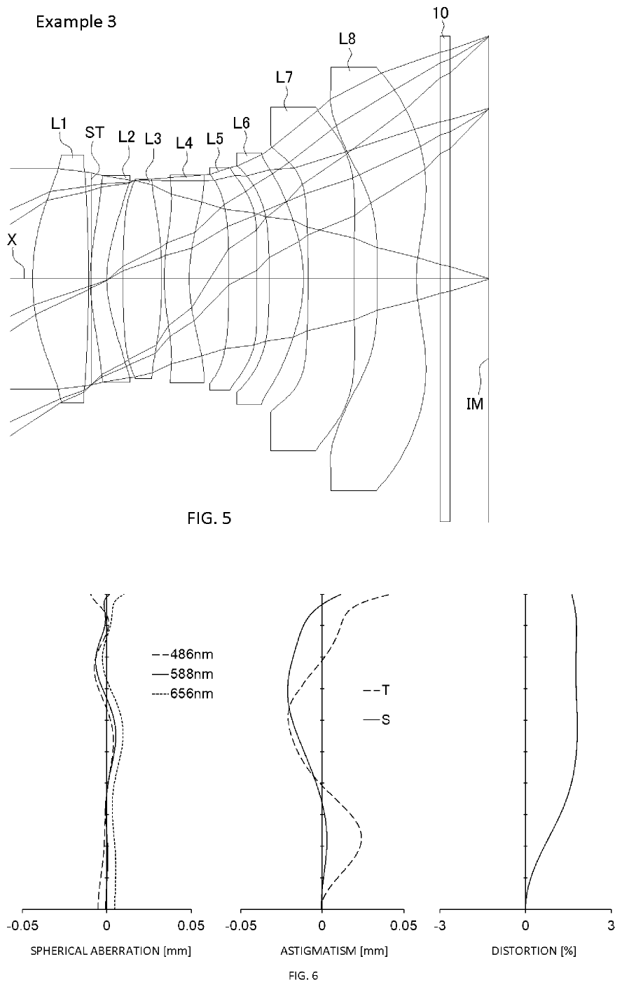

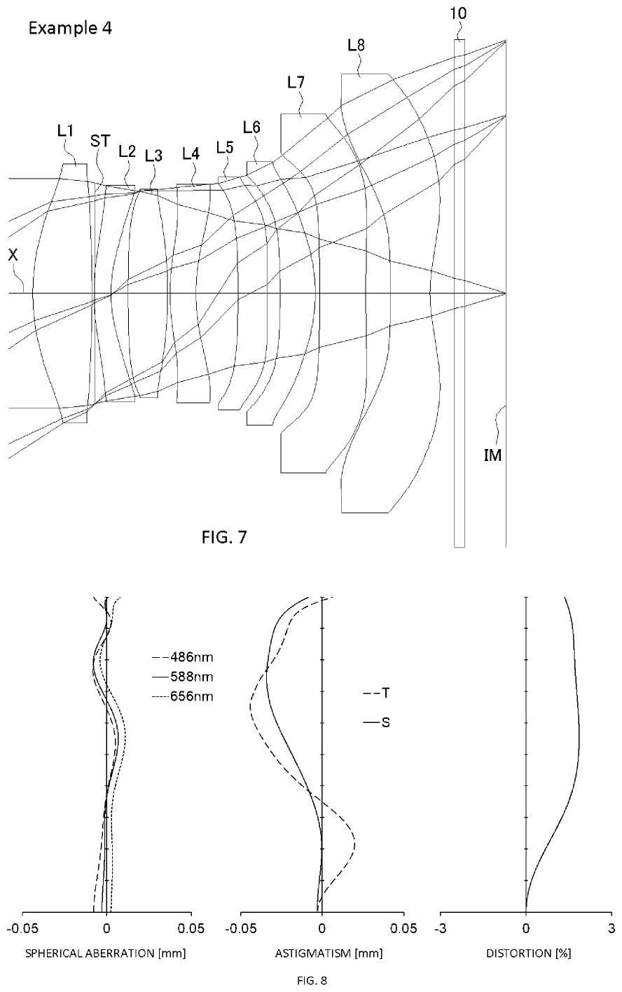

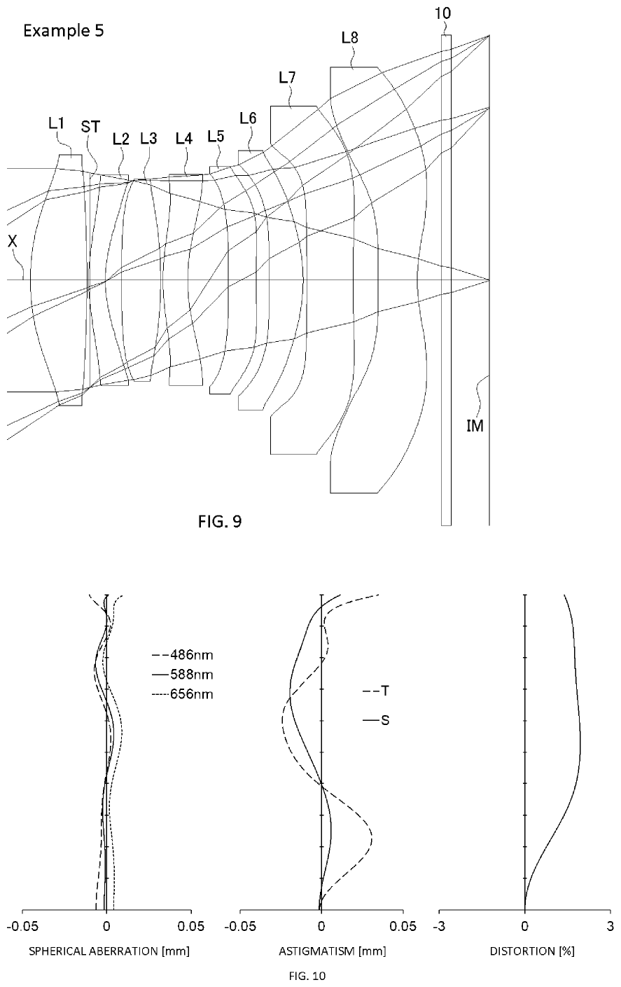

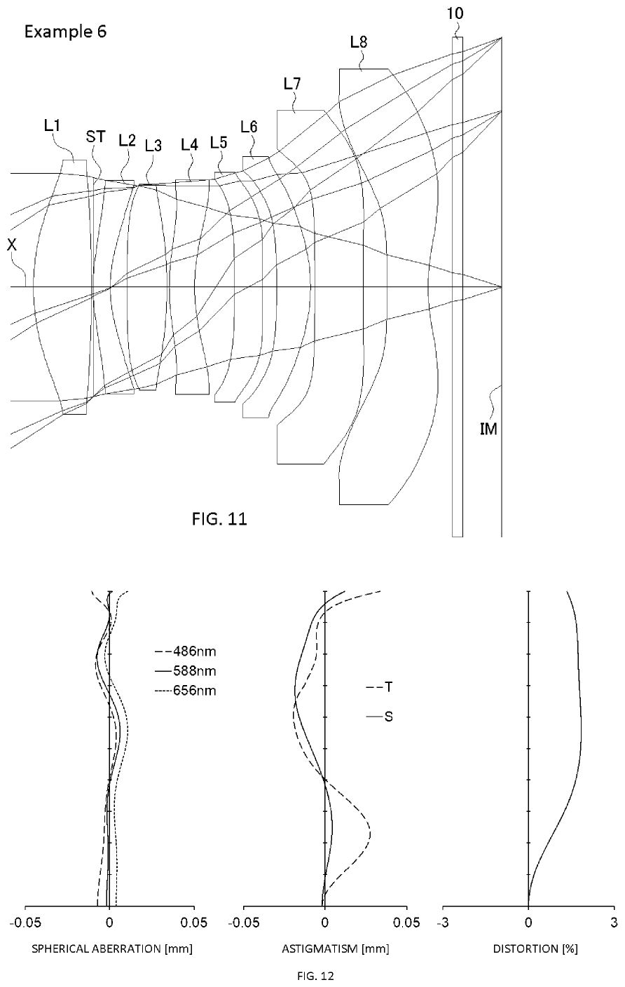

FIGS. 1, 3, 5, 7, 9, and 11 are sectional views illustrating schematic configurations of respective imaging lenses according to Examples 1 through 6 of the present embodiment. Since the imaging lenses in these Examples have the same basic configuration, a description is given here to the lens configuration according to the present embodiment with reference to the illustrative sectional view of Example 1.

As illustrated in FIG. 1, the imaging lens according to the present embodiment includes: in order from an object side to an image side, a first lens L1 having positive refractive power; a second lens L2 having negative refractive power; a third lens L3 having positive refractive power; a fourth lens L4 having negative refractive power; a fifth lens L5; a sixth lens L6; a seventh lens L7; and an eighth lens L8 having negative refractive power. Each lens of the first lens L1 to the eighth lens L8 is arranged with an air gap. A filter 10 is arranged between the eighth lens L8 and an image plane IM of the image sensor. The filter 10 is optional. It should be noted that, unless otherwise specified, refractive power of each lens herein refers to refractive power in a paraxial region.

The first lens L1 has a shape where a curvature radius r1 (=R1f) of an object-side surface is positive and a curvature radius r2 (=R1r) of an image-side surface is negative. The first lens L1 has a biconvex shape in the paraxial region. The shape of the first lens L1 is not limited to the shape according to Example 1. The first lens L1 may have a shape to provide positive refractive power. For example, the first lens L1 may have a shape where curvature radii r1 and r2 are both positive, and curvature radii r1 and r2 are negative. The former first lens L1 has a meniscus shape having the object-side surface being convex in the paraxial region, and the latter first lens L1 has a meniscus shape having the object-side surface being concave in the paraxial region.

According to the present embodiment, an aperture stop ST is arranged between the first lens L1 and the second lens L2. The position of the aperture stop ST is not limited to the position according to the Embodiment 1, and for example, the aperture stop ST may be arranged on an object side of the first lens L1. Furthermore, the aperture stop ST may be arranged between the second lens L2 and the third lens L3, or may be arranged between the third lens L3 and the fourth lens L4, or between the fourth lens L4 and the fifth lens L5.

The second lens L2 has a shape where a curvature radius r4 of an object-side surface and a curvature radius r5 of an image-side surface are both positive. The second lens L2 has a meniscus shape having the object-side surface being convex in the paraxial region. The shape of the second lens L2 is not limited to the shape according to Example 1 and may have a shape to provide negative refractive power. For example, the second lens L2 may have a meniscus shape having the object-side surface being concave in the paraxial region. Furthermore, the second lens L2 may have a shape where the curvature radius r4 is negative and the curvature radius r5 is positive, that is a biconcave shape in the paraxial region. From the perspective of miniaturization of the imaging lens, a shape where the curvature radius r4 is positive is preferable.

The third lens L3 has a shape where a curvature radius r6 of an object-side surface is positive and a curvature radius r7 of an image-side surface is negative, that is a biconvex shape in the paraxial region. The shape of the third lens L3 may have a shape to provide positive refractive power, and is not limited to the shape according to Example 1. For example, the third lens L3 may have a meniscus shape having the object-side surface being convex in the paraxial region, or a meniscus shape having the object-side surface being concave in the paraxial region. From the perspective of miniaturization of the imaging lens, a shape where the curvature radius r6 is positive is preferable.

The fourth lens L4 has a shape where a curvature radius r8 of an object-side surface and a curvature radius r9 of an image-side surface are both positive, that is a meniscus shape having the object-side surface being convex in the paraxial region. The shape of the fourth lens L4 is not limited to the shape according to Example 1. The fourth lens L4 may have a shape to provide negative refractive power. For example, the fourth lens L4 may have a biconcave shape in the paraxial region, or a meniscus shape having the object-side surface being concave in the paraxial region.

The fifth lens L5 has negative refractive power. The refractive power of the fifth lens L5 is not limited to the negative refractive power. The refractive power of the fifth lens L5 may be positive or zero in the paraxial region.

The fifth lens L5 has a shape where a curvature radius r10 of an object-side surface is negative and a curvature radius r11 of an image-side surface is positive. The fifth lens L5 has a biconcave shape in the paraxial region. The shape of the fifth lens L5 is not limited to the shape according to Example 1. For example, the fifth lens L5 may have a meniscus shape having the object-side surface being convex in the paraxial region, or a meniscus shape having the object-side surface being concave in the paraxial region. Furthermore, the shape of the fifth lens L5 may be a biconvex shape in the paraxial region. In addition, the fifth lens L5 may have a shape where the curvature radius r10 and the curvature radius r11 are both infinity, that is a shape having zero refractive power in the paraxial region and positive or negative refractive power at a lens periphery. The fifth lens L5 having such a shape has no refractive power in the paraxial region but has refractive power at the lens periphery, therefore the fifth lens L5 is effective as a lens for more correction of aberrations at the lens periphery.

The sixth lens L6 has positive refractive power. The refractive power of the sixth lens L6 is not limited to the positive refractive power. The refractive power of the sixth lens L6 may be negative or zero in the paraxial region.

The sixth lens L6 has a shape where a curvature radius r12 (=R6f) of an object-side surface and a curvature radius r13 (=R6r) of an image-side surface are both negative. The sixth lens L6 has a meniscus shape having the object-side surface being concave in the paraxial region. The shape of the sixth lens L6 is not limited to the shape according to Example 1. The sixth lens L6 may have a meniscus shape having the object-side surface being convex in the paraxial region, or a biconvex shape in the paraxial region. Furthermore, the sixth lens L6 may have a biconcave shape in the paraxial region. In addition, the sixth lens L6 as well as the fifth lens L5 may have zero refractive power in the paraxial region, and positive or negative refractive power at the lens periphery. From the perspective of satisfactory correction of the aberrations, it is preferable that the object-side surface of the sixth lens L6 is concave in the paraxial region.

The seventh lens L7 has negative refractive power. The refractive power of the seventh lens L7 is not limited to the negative refractive power. The refractive power of the seventh lens L7 may be positive or zero in the paraxial region.

The seventh lens L7 has a shape where a curvature radius r14 of an object-side surface is negative and a curvature radius r15 of an image-side surface is positive. The seventh lens L7 has a biconcave shape in a paraxial region. The shape of the seventh lens L7 is not limited to the shape according to Example 1. The seventh lens L7 may have a meniscus shape having the object-side surface being convex in the paraxial region, or a meniscus shape having the object-side surface being concave in the paraxial region. Furthermore, the seventh lens L7 may have a biconvex shape in the paraxial region. In addition, the seventh lens L7 as well as the fifth lens L5 or the sixth lens L6 may have zero refractive power in the paraxial region, and positive or negative refractive power at the lens periphery.

The eighth lens L8 has a shape where a curvature radius r16 (=R8f) of an object-side surface and a curvature radius r17 (=R8r) of an image-side surface are both positive. The eighth lens L8 has a meniscus shape having the object-side surface being convex in the paraxial region. The shape of the eighth lens L8 is not limited to the shape according to Example 1. The eighth lens L8 may have a shape to provide negative refractive power. For example, the eighth lens L8 may have a biconcave shape in the paraxial region, or a meniscus shape having the object-side surface being concave in the paraxial region. From the perspective of reduction in a profile and securing a back focus, it is preferable that the image-side surface of the eighth lens L8 is formed as a shape where the curvature radius r17 is positive, that is a concave shape in the paraxial region.

The image-side surface of the eighth lens L8 is aspheric and provided with at least one inflection point. In this context, the inflection point refers to a point where the positive or negative sign of the curvature on a curve, which is a point where the curving direction of the curve changes on the lens surface. The image-side surface the eighth lens L8 in the imaging lens according to the present embodiment has an aspheric shape with a pole point. Such a shape of the eighth lens L8 allows satisfactory correction of not only axial chromatic aberration but also off-axial chromatic aberration of magnification as well as preferable control of the incident angle of a ray of light emitted from the imaging lens into the image plane IM within the range of CRA. The surface of the image-side surface of the seventh lens L7 and both surfaces of the eighth lens L8 are aspheric surfaces having at least one inflection point in the imaging lens according to the present embodiment. Therefore, aberrations at an image periphery can be more satisfactorily corrected. It should be noted that, depending on the expected optical performance and the extent of reduction in the profile of the imaging lens, the seventh lens L7 and the eighth lens L8 may have other surfaces except the image-side surface of the eighth lens L8 formed as aspheric surfaces with no inflection point.

The imaging lens according to the present embodiment satisfies the following conditional expressions (1) through (20):

3.5<|R1r/R1f|<8.5

1.35<f3/f<4.50

1.20<f3/f1<4.50

−12.00<f4/f<−3.00

−5.50<f4/f3<−0.80

−8.00<f234/f<−2.00

2.0<D45/D56<4.0

1.0<R6f/R6r<30.0

−2.50<f2/f6<−0.30

0.50<f3/f6<2.50

−15.00<f7/f<−3.50

0.50<f67/f<4.00

1.0<R8f/R8r<100.0

20.0<R8f/R8r<100.0.

0.05<f8/f7<0.80

0.03<D78/f<0.15

35<vd3

35<vd3<90

35<vd4

35<vd4<90.

vd7<35

15<vd7<35

35<vd8

35<vd8<90, and

TL/f<1.3
where
f: a focal length of entire optical system of the imaging lens,
f1: a focal length of the first lens L1,
f2: a focal length of the second lens L2,
f3: a focal length of the third lens L3,
f4: a focal length of the fourth lens L4,
f6: a focal length of the sixth lens L6,
f7: a focal length of the seventh lens L7,
f8: a focal length of the eighth lens L8,
f67: a composite focal length of the sixth lens L6 and the seventh lens L7,
f234: a composite focal length of the second lens L2, the third lens L3, and the fourth lens L4,
vd3: an abbe number at d-ray of the third lens L3,
vd4: an abbe number at d-ray of the fourth lens L4,
vd7: an abbe number at d-ray of the seventh lens L7,
vd8: an abbe number at d-ray of the eighth lens L5,
R1f: a curvature radius of an object-side surface of the first lens L1,
R1r: a curvature radius of an image-side surface of the first lens L1,
R6f: a curvature radius of an object-side surface of the sixth lens L6,
R6r: a curvature radius of an image-side surface of the sixth lens L6,
R8f: a curvature radius of an object-side surface of the eighth lens L8,
R8r: a curvature radius of an image-side surface of the eighth lens L8,
D45: a distance along the optical axis between the fourth lens L4 and the fifth lens L5,
D56: a distance along the optical axis between the fifth lens L5 and the sixth lens L6,
D78: a distance along the optical axis between the seventh lens L7 and the eighth lens L8, and
TL: a distance along the optical axis X from an object-side surface of the first lens L1 to an image plane (a filter 10 is an air equivalent length).

The imaging lens according to the present embodiment satisfies the following conditional expression:

65°≤2ω
where
ω: a half field of view.

It should be noted that not all the above conditional expressions have to be satisfied and each of the above conditional expressions may be individually satisfied to obtain the operational advantage corresponding to each conditional expression.

According to the present embodiment, lens surfaces of the respective lenses are formed as aspheric surfaces. An equation that expresses these aspheric surfaces is as below:

$$Z = \frac{C \cdot {H}^{2}}{1 + \sqrt{1 - ( 1 + k ) \cdot {C}^{2} \cdot {H}^{2}}} + \sum ( An \cdot {H}^{n} ) \qquad [ Equation 1 ]$$

where
Z: a distance in the direction of the optical axis,
H: a distance from the optical axis in the direction perpendicular to the optical axis,
C: a paraxial curvature (=1/r, r: paraxial curvature radius),
k: conic constant, and
An: the nth aspheric coefficient.

Next, Examples of the imaging lens according to the present embodiment will be described. In each table showing basic lens data, f represents a focal length of the entire optical system of the imaging lens, Fno represents a F-number, ω represents a half field of view. Additionally, i represents a surface number counted from the object side, r represents a paraxial curvature radius, d represents a distance between lens surfaces along the optical axis X, nd represents a refractive index at a reference wavelength of 588 nm, and vd represents an abbe number at the reference wavelength. It should be noted that surfaces indicated by surface numbers i affixed with an asterisk (*) are aspheric surfaces.

### EXAMPLE 1

The basic lens data is shown below in Table 1.

TABLE 1
f = 7.71 mm Fno = 1.5 ω = 33.4°

| | i | r | d | n d | νd | [mm] |
|---|---|---|---|---|---|---|
| | | ∞ | ∞ | | | |
| L1 | 1* | 4.506 | 1.204 | 1.5348 | 55.7 | f1 = 7.112 |
| | 2* | −22.119 | 0.059 | | | |
| ST | 3 | ∞ | −0.027 | | | |
| L2 | 4* | 3.906 | 0.350 | 1.6608 | 20.4 | f2 = −12.380 |
| | 5* | 2.549 | 0.342 | | | |
| L3 | 6* | 35.217 | 0.823 | 1.5348 | 55.7 | f3 = 13.565 |
| | 7* | −9.062 | 0.050 | | | |
| L4 | 8* | 4.667 | 0.526 | 1.5348 | 55.7 | f4 = −47.858 |
| | 9* | 3.792 | 0.821 | | | |
| L5 | 10* | −100.000 | 0.590 | 1.5348 | 55.7 | f5 = −31.588 |
| | 11* | 20.370 | 0.276 | | | |
| L6 | 12* | −22.934 | 0.692 | 1.5348 | 55.7 | f6 = 7.716 |
| | 13* | −3.534 | 0.105 | | | |
| L7 | 14* | −46.496 | 1.000 | 1.6392 | 23.5 | f7 = −51.063 |
| | 15* | 110.418 | 0.505 | | | |
| L8 | 16* | 100.000 | 0.825 | 1.5348 | 55.7 | f8 = −6.807 |
| | 17* | 3.503 | 0.500 | | | |
| | 18 | ∞ | 0.210 | 1.5168 | 64.2 | |
| | 19 | ∞ | 0.804 | | | |
| (IM) | | ∞ | | | | |

f234=−37.310 mm

f67=9.047 mm

R1f=4.506 mm

R1r=−22.119 mm

R6f=−22.934 mm

R6r=−3.534 mm

R8f=100.000 mm

R8r=3.503 mm

D45=0.821 mm

D56=0.276 mm

D78=0.505 mm

TL=9.587 mm

TABLE 2
Aspheric surface Data:

| i | k | A4 | A6 | A8 | A10 | A12 | A14 | A16 |
|---|---|---|---|---|---|---|---|---|
| 1 | 0.000E+00 | 5.373E−04 | −1.236E−03 | 2.010E−04 | −2.497E−05 | 2.851E−07 | 6.967E−08 | 0.000E+00 |
| 2 | 0.000E+00 | 2.489E−03 | 6.196E−05 | −9.329E−05 | 3.003E−06 | 4.954E−07 | 1.173E−10 | 0.000E+00 |
| 4 | 0.000E+00 | −4.123E−02 | 1.095E−02 | −2.061E−03 | 1.728E−04 | −4.243E−07 | −3.364E−07 | 0.000E+00 |
| 5 | 0.000E+00 | −5.354E−02 | 1.249E−02 | −2.938E−03 | 4.202E−04 | −3.348E−05 | 4.670E−07 | 0.000E+00 |
| 6 | 0.000E+00 | 8.435E−03 | −1.669E−03 | 6.834E−04 | −4.514E−05 | −1.904E−06 | 9.764E−08 | 1.703E−08 |
| 7 | 0.000E+00 | −1.231E−03 | 2.412E−04 | 4.335E−05 | −6.275E−06 | 3.300E−06 | 3.181E−07 | −2.785E−08 |
| 8 | 0.000E+00 | −1.955E−02 | −3.437E−04 | −5.716E−05 | 2.603E−05 | 2.971E−06 | 1.296E−07 | −2.424E−08 |
| 9 | 0.000E+00 | −1.382E−02 | −1.427E−03 | 2.663E−04 | −1.826E−05 | −4.225E−06 | 3.407E−07 | 4.094E−08 |
| 10 | 0.000E+00 | −1.624E−02 | 2.816E−03 | −6.437E−04 | 5.478E−05 | −9.591E−06 | 2.205E−07 | 1.168E−07 |
| 11 | 0.000E+00 | −2.506E−02 | −1.306E−03 | 2.211E−04 | 1.476E−05 | −2.013E−06 | −3.051E−08 | 9.897E−08 |
| 12 | 0.000E+00 | −1.314E−02 | −1.131E−03 | −3.656E−05 | 2.319E−06 | 4.212E−06 | 5.344E−07 | −1.303E−07 |
| 13 | −1.048E+00 | 2.883E−03 | 2.410E−03 | −7.212E−04 | 4.759E−05 | −5.957E−07 | 6.945E−08 | 1.904E−08 |
| 14 | 0.000E+00 | 2.649E−03 | 3.118E−04 | −1.119E−03 | 2.872E−04 | −3.719E−05 | 1.733E−06 | 1.719E−08 |
| 15 | 0.000E+00 | 7.813E−03 | −4.524E−03 | 8.912E−04 | −1.142E−04 | 8.853E−06 | −3.763E−07 | 6.882E−09 |
| 16 | 0.000E+00 | −2.595E−02 | 9.010E−04 | 3.837E−04 | −5.181E−05 | 2.694E−06 | −5.725E−08 | 2.826E−10 |
| 17 | −6.971E+00 | −2.097E−02 | 2.559E−03 | −2.355E−04 | 1.443E−05 | −4.877E−07 | 6.098E−09 | 2.502E−11 |

A value of each conditional expression is described below.

|R1r/R1f|=4.9

f3/f=1.76

f3/f1=1.91

f4/f=−6.21

f4/f3=−3.53

f234/f=−4.84

D45/D56=3.0

R6f/R6r=6.5

f2/f6=−1.60

f3/f6=1.76

f7/f=−6.62

f67/f=1.17

R8f/R8r=28.6

f8/f7=0.13

D78/f=0.07

TL/f=1.2

The imaging lens according to Example 1 satisfies the above-described conditional expressions.

FIG. 2 is an aberration diagram illustrating spherical aberration (mm), astigmatism (mm), and distortion (%) of the imaging lens in Example 1, respectively. The astigmatism diagram and distortion diagram represent the aberrations at the reference wavelength (588 nm). Furthermore, the astigmatism diagram represents a sagittal image surface (S) and a tangential image surface (T), respectively (same in FIGS. 4, 6, 8, 10, 12, 14, 16, 18, 20, 22 and 24). As shown in FIG. 2, the imaging lens according to Example 1 is capable of satisfactorily correcting the aberrations.

### EXAMPLE 2

The basic lens data is shown below in Table 3.

TABLE 3
f = 7.71 mm Fno = 1.5 ω = 33.4°

| | i | r | d | n d | νd | [mm] |
|---|---|---|---|---|---|---|
| | | ∞ | ∞ | | | |
| L1 | 1* | 4.510 | 1.203 | 1.5348 | 55.7 | f1 = 7.123 |
| | 2* | −22.244 | 0.062 | | | |
| ST | 3 | ∞ | −0.026 | | | |
| L2 | 4* | 3.908 | 0.350 | 1.6608 | 20.4 | f2 = −12.362 |
| | 5* | 2.549 | 0.335 | | | |
| L3 | 6* | 29.615 | 0.845 | 1.5348 | 55.7 | f3 = 12.747 |
| | 7* | −8.768 | 0.050 | | | |
| L4 | 8* | 4.843 | 0.534 | 1.5348 | 55.7 | f4 = −38.291 |
| | 9* | 3.766 | 0.800 | | | |
| L5 | 10* | −98.878 | 0.583 | 1.5348 | 55.7 | f5 = −31.632 |
| | 11* | 20.451 | 0.278 | | | |
| L6 | 12* | −21.499 | 0.697 | 1.5348 | 55.7 | f6 = 7.677 |
| | 13* | −3.486 | 0.102 | | | |
| L7 | 14* | −48.178 | 0.999 | 1.6392 | 23.5 | f7 = −51.479 |
| | 15* | 104.620 | 0.504 | | | |
| L8 | 16* | 99.999 | 0.828 | 1.5348 | 55.7 | f8 = −6.808 |
| | 17* | 3.503 | 0.500 | | | |
| | 18 | ∞ | 0.210 | 1.5168 | 64.2 | |
| | 19 | ∞ | 0.804 | | | |
| (IM) | | ∞ | | | | |

f234=−36.738 mm

f67=8.980 mm

R1f=4.510 mm

R1r=−22.244 mm

R6f=−21.499 mm

R6r=−3.486 mm

R8f=99.999 mm

R8r=3.503 mm

D45=0.800 mm

D56=0.278 mm

D78=0.504 mm

TL=9.587 mm

TABLE 4
Aspheric surface Data:

| i | k | A4 | A6 | A8 | A10 | A12 | A14 | A16 |
|---|---|---|---|---|---|---|---|---|
| 1 | 0.000E+00 | 5.242E−04 | −1.237E−03 | 2.009E−04 | −2.499E−05 | 2.808E−07 | 6.845E−08 | 0.000E+00 |
| 2 | 0.000E+00 | 2.504E−03 | 6.249E−05 | −9.336E−05 | 2.983E−06 | 4.932E−07 | 3.621E−10 | 0.000E+00 |
| 4 | 0.000E+00 | −4.125E−02 | 1.095E−02 | −2.061E−03 | 1.729 E−04 | −4.125E−07 | −3.348E−07 | 0.000E+00 |
| 5 | 0.000E+00 | −5.353E−02 | 1.249E−02 | −2.938E−03 | 4.200E−04 | −3.351E−05 | 4.622E−07 | 0.000E+00 |
| 6 | 0.000E+00 | 8.407E−03 | −1.669E−03 | 6.838E−04 | −4.508E−05 | −1.904E−06 | 9.423E−08 | 1.582E−08 |
| 7 | 0.000E+00 | −1.219E−03 | 2.401E−04 | 4.292E−05 | −6.335E−06 | 3.304E−06 | 3.227E−07 | −2.637E−08 |
| 8 | 0.000E+00 | −1.957E−02 | −3.434E−04 | −5.586E−05 | 2.665E−05 | 3.146E−06 | 1.525E−07 | −3.112E−08 |
| 9 | 0.000E+00 | −1.381E−02 | −1.411E−03 | 2.720E−04 | −1.760E−05 | −4.320E−06 | 2.968E−07 | 3.788E−08 |
| 10 | 0.000E+00 | −1.619E−02 | 2.838E−03 | −6.421E−04 | 5.440E−05 | −9.696E−06 | 2.087E−07 | 1.153E−07 |
| 11 | 0.000E+00 | −2.508E−02 | −1.306E−03 | 2.231E−04 | 1.505E−05 | −1.969E−06 | −1.451E−08 | 1.053E−07 |
| 12 | 0.000E+00 | −1.309E−02 | −1.119E−03 | −3.528E−05 | 2.766E−06 | 4.307E−06 | 5.438E−07 | −1.316E−07 |
| 13 | −1.037E+00 | 2.851E−03 | 2.412E−03 | −7.213E−04 | 4.747E−05 | −6.045E−07 | 7.243E−08 | 2.040E−08 |
| 14 | 0.000E+00 | 2.660E−03 | 3.019E−04 | −1.121E−03 | 2.872E−04 | −3.718E−05 | 1.735E−06 | 1.738E−08 |
| 15 | 0.000E+00 | 7.760E−03 | −4.525E−03 | 8.913E−04 | −1.142E−04 | 8.853E−06 | −3.763E−07 | 6.884E−09 |
| 16 | 0.000E+00 | −2.596E−02 | 9.022E−04 | 3.837E−04 | −5.181E−05 | 2.694E−06 | −5.726E−08 | 2.825E−10 |
| 17 | −7.002E+00 | −2.097E−02 | 2.559E−03 | −2.355E−04 | 1.443E−05 | −4.877E−07 | 6.096E−09 | 2.517E−11 |

A value of each conditional expression is described below.

|R1r/R1f|=4.9

f3/f=1.65

f3/f1=1.79

f4/f=−4.97

f4/f3=−3.00

f234/f=−4.77

D45/D56=2.9

R6f/R6r=6.2

f2/f6=−1.61

f3/f6=1.66

f7/f=−6.68

f67/f=1.17

R8f/R8r=28.5

f8/f7=0.13

D78/f=0.07

TL/f=1.2

The imaging lens according to Example 2 satisfies the above-described conditional expressions. As shown in FIG. 4, the imaging lens according to Example 2 can also satisfactorily correct aberrations.

### EXAMPLE 3

The basic lens data is shown below in Table 5.

TABLE 5
f = 7.69 mm Fno = 1.5 ω = 33.4°

| | i | r | d | n d | νd | [mm] |
|---|---|---|---|---|---|---|
| | | ∞ | ∞ | | | |
| L1 | 1* | 4.524 | 1.190 | 1.5348 | 55.7 | f1 = 7.144 |
| | 2* | −22.327 | 0.058 | | | |
| ST | 3 | ∞ | −0.026 | | | |
| L2 | 4* | 3.888 | 0.350 | 1.6608 | 20.4 | f2 = −12.533 |
| | 5* | 2.551 | 0.342 | | | |
| L3 | 6* | 34.842 | 0.825 | 1.5348 | 55.7 | f3 = 13.499 |
| | 7* | −9.031 | 0.050 | | | |
| L4 | 8* | 4.653 | 0.531 | 1.5348 | 55.7 | f4 = −46.807 |
| | 9* | 3.768 | 0.837 | | | |
| L5 | 10* | −60.755 | 0.589 | 1.5348 | 55.7 | f5 = −27.052 |
| | 11* | 19.054 | 0.263 | | | |
| L6 | 12* | −32.131 | 0.729 | 1.5348 | 55.7 | f6 = 6.913 |
| | 13* | −3.342 | 0.098 | | | |
| L7 | 14* | −29.275 | 0.975 | 1.6392 | 23.5 | f7 = −36.505 |
| | 15* | 116.433 | 0.487 | | | |
| L8 | 16* | 100.000 | 0.831 | 1.5348 | 55.7 | f8 = −6.725 |
| | 17* | 3.462 | 0.500 | | | |
| | 18 | ∞ | 0.210 | 1.5168 | 64.2 | |
| | 19 | ∞ | 0.818 | | | |
| (IM) | | ∞ | | | | |

f234=−38.589 mm

f67=8.481 mm

R1f=4.524 mm

R1r=−22.327 mm

R6f=−32.131 mm

R6r=−3.342 mm

R8f=100.000 mm

R8r=3.462 mm

D45=0.837 mm

D56=0.263 mm

D78=0.487 mm

TL=9.587 mm

TABLE 6
Aspheric Surface Data:

| i | k | A4 | A6 | A8 | A10 | A12 | A14 | A16 |
|---|---|---|---|---|---|---|---|---|
| 1 | 0.000E+00 | 5.274E−04 | −1.237E−03 | 2.010E−04 | −2.498E−05 | 2.811E−07 | 6.810E−08 | 0.000E+00 |
| 2 | 0.000E+00 | 2.491E−03 | 6.257E−05 | −9.315E−05 | 3.011E−06 | 4.905E−07 | −2.529E−09 | 0.000E+00 |
| 4 | 0.000E+00 | −4.124E−02 | 1.095E−02 | −2.061E−03 | 1.728E−04 | −4.200E−07 | −3.348E−07 | 0.000E+00 |
| 5 | 0.000E+00 | −5.354E−02 | 1.249E−02 | −2.937E−03 | 4.202E−04 | −3.347E−05 | 4.720E−07 | 0.000E+00 |
| 6 | 0.000E+00 | 8.438E−03 | −1.668E−03 | 6.836E−04 | −4.505E−05 | −1.877E−06 | 1.013E−07 | 1.627E−08 |
| 7 | 0.000E+00 | −1.226E−03 | 2.428E−04 | 4.360E−05 | −6.287E−06 | 3.284E−06 | 3.135E−07 | −2.844E−08 |
| 8 | 0.000E+00 | −1.959E−02 | −3.529E−04 | −5.833E−05 | 2.592E−05 | 2.917E−06 | 1.116E−07 | −2.342E−08 |
| 9 | 0.000E+00 | −1.376E−02 | −1.411E−03 | 2.672E−04 | −1.813E−05 | −4.072E−06 | 3.739E−07 | 3.656E−08 |
| 10 | 0.000E+00 | −1.636E−02 | 2.829E−03 | −6.363E−04 | 5.507E−05 | −9.770E−06 | 1.952E−07 | 1.265E−07 |
| 11 | 0.000E+00 | −2.496E−02 | −1.330E−03 | 2.156E−04 | 1.420E−05 | −2.079E−06 | −4.965E−08 | 9.214E−08 |
| 12 | 0.000E+00 | −1.326E−02 | −1.109E−03 | −3.477E−05 | 1.864E−06 | 4.087E−06 | 5.230E−07 | −1.274E−07 |
| 13 | −1.112E+00 | 3.068E−03 | 2.412E−03 | −7.195E−04 | 4.787E−05 | −5.728E−07 | 6.984E−08 | 1.882E−08 |
| 14 | 0.000E+00 | 2.961E−03 | 3.347E−04 | −1.125E−03 | 2.867E−04 | −3.719E−05 | 1.739E−06 | 1.800E−08 |
| 15 | 0.000E+00 | 7.594E−03 | −4.521E−03 | 8.913E−04 | −1.142E−04 | 8.852E−06 | −3.762E−07 | 6.905E−09 |
| 16 | 0.000E+00 | −2.587E−02 | 9.027E−04 | 3.837E−04 | −5.181E−05 | 2.694E−06 | −5.726E−08 | 2.839E−10 |
| 17 | −7.078E+00 | −2.085E−02 | 2.558E−03 | −2.353E−04 | 1.443E−05 | −4.878E−07 | 6.088E−09 | 2.463E−11 |

A value of each conditional expression is described below.

|R1r/R1f|=4.9

f3/f=1.75

f3/f1=1.89

f4/f=−6.08

f4/f=−3.47

f234/f=−5.02

D45/D56=3.2

R6f/R6r=9.6

f2/f6=−1.81

f3/f6=1.95

f7/f=−4.74

f67/f=1.10

R8f/R8r=28.9

f8/f7=0.18

D78/f=0.06

TL/f=1.2

The imaging lens according to Example 3 satisfies the above-described conditional expressions. As shown in FIG. 6, the imaging lens according to Example 3 can also satisfactorily correct aberrations.

### EXAMPLE 4

The basic lens data is shown below in Table 7.

TABLE 7
f = 7.71 mm Fno = 1.5 ω = 33.4°

| | i | r | d | n d | νd | [mm] |
|---|---|---|---|---|---|---|
| | | ∞ | ∞ | | | |
| L1 | 1* | 4.511 | 1.211 | 1.5348 | 55.7 | f1 = 7.110 |
| | 2* | −21.940 | 0.056 | | | |
| ST | 3 | ∞ | −0.024 | | | |
| L2 | 4* | 3.902 | 0.350 | 1.6608 | 20.4 | f2 = −12.418 |
| | 5* | 2.550 | 0.353 | | | |
| L3 | 6* | 44.956 | 0.806 | 1.5348 | 55.7 | f3 = 14.451 |
| | 7* | −9.275 | 0.050 | | | |
| L4 | 8* | 4.542 | 0.528 | 1.5348 | 55.7 | f4 = −61.246 |
| | 9* | 3.827 | 0.855 | | | |
| L5 | 10* | −97.032 | 0.593 | 1.5348 | 55.7 | f5 = −28.406 |
| | 11* | 18.050 | 0.268 | | | |
| L6 | 12* | −33.019 | 0.719 | 1.5348 | 55.7 | f6 = 7.073 |
| | 13* | −3.420 | 0.092 | | | |
| L7 | 14* | −34.282 | 0.942 | 1.6392 | 23.5 | f7 = −39.029 |
| | 15* | 92.576 | 0.495 | | | |
| L8 | 16* | 100.000 | 0.814 | 1.5348 | 55.7 | f8 = −6.759 |
| | 17* | 3.479 | 0.500 | | | |
| | 18 | ∞ | 0.210 | 1.5168 | 64.2 | |
| | 19 | ∞ | 0.840 | | | |
| (IM) | | ∞ | | | | |

f234=−37.518 mm

f67=8.586 mm

R1f=4.511 mm

R1r=−21.940 mm

R6f=−33.019 mm

R6r=−3.420 mm

R8f=100.000 mm

R8r=3.479 mm

D45=0.855 mm

D56=0.268 mm

D78=0.495 mm

TL=9.588 mm

TABLE 8
Aspheric Surface Data:

| i | k | A4 | A6 | A8 | A10 | A12 | A14 | A16 |
|---|---|---|---|---|---|---|---|---|
| 1 | 0.000E+00 | 5.460E−04 | −1.234E−03 | 2.014E−04 | −2.492E−05 | 2.925E−07 | 7.029E−08 | 0.000E+00 |
| 2 | 0.000E+00 | 2.472E−03 | 6.053E−05 | −9.331E−05 | 3.025E−06 | 5.012E−07 | 1.015E−09 | 0.000E+00 |
| 4 | 0.000E+00 | −4.122E−02 | 1.095E−02 | −2.061E−03 | 1.727E−04 | −4.369E−07 | −3.389E−07 | 0.000E+00 |
| 5 | 0.000E+00 | −5.356E−02 | 1.249E−02 | −2.937E−03 | 4.203E−04 | −3.346E−05 | 4.707E−07 | 0.000E+00 |
| 6 | 0.000E+00 | 8.466E−03 | −1.668E−03 | 6.831E−04 | −4.519E−05 | −1.897E−06 | 1.034E−07 | 1.905E−08 |
| 7 | 0.000E+00 | −1.234E−03 | 2.449E−04 | 4.452E−05 | −6.062E−06 | 3.319E−06 | 3.125E−07 | −3.192E−08 |
| 8 | 0.000E+00 | −1.956E−02 | −3.503E−04 | −5.923E−05 | 2.538E−05 | 2.770E−06 | 8.527E−08 | −2.599E−08 |
| 9 | 0.000E+00 | −1.378E−02 | −1.429E−03 | 2.623E−04 | −1.892E−05 | −4.167E−06 | 3.724E−07 | 3.998E−08 |
| 10 | 0.000E+00 | −1.635E−02 | 2.805E−03 | −6.408E−04 | 5.548E−05 | −9.531E−06 | 2.293E−07 | 1.237E−07 |
| 11 | 0.000E+00 | −2.498E−02 | −1.314E−03 | 2.176E−04 | 1.424E−05 | −2.099E−06 | −5.443E−08 | 9.123E−08 |
| 12 | 0.000E+00 | −1.327E−02 | −1.135E−03 | −3.750E−05 | 1.801E−06 | 4.106E−06 | 5.253E−07 | −1.282E−07 |
| 13 | −1.108E+00 | 3.052E−03 | 2.419E−03 | −7.195E−04 | 4.782E−05 | −5.826E−07 | 6.714E−08 | 1.805E−08 |
| 14 | 0.000E+00 | 2.747E−03 | 3.319E−04 | −1.120E−03 | 2.871E−04 | −3.719E−05 | 1.735E−06 | 1.744E−08 |
| 15 | 0.000E+00 | 7.612E−03 | −4.527E−03 | 8.911E−04 | −1.142E−04 | 8.853E−06 | −3.762E−07 | 6.890E−09 |
| 16 | 0.000E+00 | −2.591E−02 | 9.016E−04 | 3.837E−04 | −5.181E−05 | 2.694E−06 | −5.726E−08 | 2.826E−10 |
| 17 | −7.048E+00 | −2.097E−02 | 2.560E−03 | −2.354E−04 | 1.443E−05 | −4.877E−07 | 6.093E−09 | 2.486E−11 |

A value of each conditional expression is described below.

|R1r/R1f|=4.9

f3/f=1.87

f3/f1=2.03

f4/f=−7.94

f4/f=−4.24

f234/f=−4.87

D45/D56=3.2

R6f/R6r=9.7

f2/f6=−1.76

f3/f6=2.04

f7/f=−5.06

f67/f=1.11

R8f/R8r=28.7

f8/f7=0.17

D78/f=0.06

TL/f=1.2

The imaging lens according to Example 4 satisfies the above-described conditional expressions. As shown in FIG. 8, the imaging lens according to Example 4 can also satisfactorily correct aberrations.

### EXAMPLE 5

The basic lens data is shown below in Table 9.

TABLE 9
f = 7.71 mm Fno = 1.5 ω = 33.4°

| | i | r | d | n d | νd | [mm] |
|---|---|---|---|---|---|---|
| | | ∞ | ∞ | | | |
| L1 | 1* | 4.508 | 1.193 | 1.5348 | 55.7 | f1 = 7.127 |
| | 2* | −22.400 | 0.056 | | | |
| ST | 3 | ∞ | −0.023 | | | |
| L2 | 4* | 3.903 | 0.350 | 1.6608 | 20.4 | f2 = −12.433 |
| | 5* | 2.552 | 0.342 | | | |
| L3 | 6* | 36.520 | 0.823 | 1.5348 | 55.7 | f3 = 13.552 |
| | 7* | −8.971 | 0.050 | | | |
| L4 | 8* | 4.681 | 0.521 | 1.5348 | 55.7 | f4 = −47.392 |
| | 9* | 3.798 | 0.853 | | | |
| L5 | 10* | −99.940 | 0.587 | 1.5348 | 55.7 | f5 = −25.714 |
| | 11* | 15.979 | 0.273 | | | |
| L6 | 12* | −100.002 | 0.715 | 1.5348 | 55.7 | f6 = 7.197 |
| | 13* | −3.716 | 0.080 | | | |
| L7 | 14* | −40.951 | 0.975 | 1.6392 | 23.5 | f7 = −45.170 |
| | 15* | 98.774 | 0.521 | | | |
| L8 | 16* | 100.000 | 0.826 | 1.5348 | 55.7 | f8 = −6.816 |
| | 17* | 3.507 | 0.500 | | | |
| | 18 | ∞ | 0.210 | 1.5168 | 64.2 | |
| | 19 | ∞ | 0.805 | | | |
| (IM) | | ∞ | | | | |

f234=−37.630 mm

f67=8.509 mm

R1f=4.508 mm

R1r=−22.400 mm

R6f=−100.002 mm

R6r=−3.716 mm

R8f=100.000 mm

R8r=3.507 mm

D45=0.853 mm

D56=0.273 mm

D78=0.521 mm

TL=9.587 mm

TABLE 10
Aspheric Surface Data:

| | k | A4 | A6 | A8 | A10 | A12 | A14 | A16 |
|---|---|---|---|---|---|---|---|---|
| 1 | 0.000E+00 | 5.144E−04 | −1.237E−03 | 2.009E−04 | −2.502E−05 | 2.742E−07 | 6.810E−08 | 0.000E+00 |
| 2 | 0.000E+00 | 2.496E−03 | 6.310E−05 | −9.320E−05 | 2.967E−06 | 4.816E−07 | −2.834E−09 | 0.000E+00 |
| 4 | 0.000E+00 | −4.123E−02 | 1.095E−02 | −2.061E−03 | 1.729E−04 | −4.262E−07 | −3.441E−07 | 0.000E+00 |
| 5 | 0.000E+00 | −5.354E−02 | 1.249E−02 | −2.938E−03 | 4.201E−04 | −3.349E−05 | 4.660E−07 | 0.000E+00 |
| 6 | 0.000E+00 | 8.432E−03 | −1.669E−03 | 6.832E−04 | −4.520E−05 | −1.920E−06 | 9.660E−08 | 1.946E−08 |
| 7 | 0.000E+00 | −1.229E−03 | 2.424E−04 | 4.377E−05 | −6.093E−06 | 3.368E−06 | 3.310E−07 | −3.265E−08 |
| 8 | 0.000E+00 | −1.958E−02 | −3.469E−04 | −5.451E−05 | 2.705E−05 | 3.098E−06 | 1.108E−07 | −3.649E−08 |
| 9 | 0.000E+00 | −1.377E−02 | −1.392E−03 | 2.733E−04 | −1.717E−05 | −4.081E−06 | 3.472E−07 | 4.870E−08 |
| 10 | 0.000E+00 | −1.599E−02 | 2.838E−03 | −6.441E−04 | 5.492E−05 | −9.479E−06 | 2.422E−07 | 1.080E−07 |
| 11 | 0.000E+00 | −2.527E−02 | −1.274E−03 | 2.279E−04 | 1.415E−05 | −2.374E−06 | −9.998E−08 | 9.452E−08 |
| 12 | 0.000E+00 | −1.296E−02 | −1.138E−03 | −3.871E−05 | 2.289E−06 | 4.241E−06 | 5.341E−07 | −1.424E−07 |
| 13 | −1.151E+00 | 3.138E−03 | 2.457E−03 | −7.197E−04 | 4.731E−05 | −6.996E−07 | 4.686E−08 | 1.517E−08 |
| 14 | 0.000E+00 | 3.077E−03 | 3.943E−04 | −1.120E−03 | 2.867E−04 | −3.723E−05 | 1.732E−06 | 1.692E−08 |
| 15 | 0.000E+00 | 8.185E−03 | −4.540E−03 | 8.904E−04 | −1.142E−04 | 8.853E−06 | −3.762E−07 | 6.902E−09 |
| 16 | 0.000E+00 | −2.602E−02 | 9.095E−04 | 3.839E−04 | −5.181E−05 | 2.694E−06 | −5.728E−08 | 2.819E−10 |
| 17 | −6.743E+00 | −2.107E−02 | 2.553E−03 | −2.350E−04 | 1.445E−05 | −4.875E−07 | 6.078E−09 | 2.348E−11 |

A value of each conditional expression is described below.

|R1r/R1f|=5.0

f3/f=1.76

f3/f1=1.90

f4/f=−6.15

f4/f=−3.50

f234/f=−4.88

D45/D56=3.1

R6f/R6r=26.9

f2/f6=−1.73

f3/f6=1.88

f7/f=−5.86

f67/f=1.10

R8f/R8r=28.5

f8/f7=0.15

D78/f=0.07

TL/f=1.2

The imaging lens according to Example 5 satisfies the above-described conditional expressions. As shown in FIG. 10, the imaging lens according to Example 5 can also satisfactorily correct aberrations.

### EXAMPLE 6

The basic lens data is shown below in Table 11.

TABLE 11
f = 7.71 mm Fno = 1.5 ω = 33.4°

| | i | r | d | n d | νd | [mm] |
|---|---|---|---|---|---|---|
| | | ∞ | ∞ | | | |
| L1 | 1* | 4.489 | 1.199 | 1.5348 | 55.7 | f1 = 7.062 |
| | 2* | −21.600 | 0.035 | | | |
| ST | 3 | ∞ | −0.002 | | | |
| L2 | 4* | 3.907 | 0.350 | 1.6608 | 20.4 | f2 = −12.384 |
| | 5* | 2.550 | 0.343 | | | |
| L3 | 6* | 37.839 | 0.829 | 1.5348 | 55.7 | f3 = 13.515 |
| | 7* | −8.867 | 0.050 | | | |
| L4 | 8* | 4.732 | 0.520 | 1.5348 | 55.7 | f4 = −47.060 |
| | 9* | 3.830 | 0.824 | | | |
| L5 | 10* | −63.598 | 0.580 | 1.5348 | 55.7 | f5 = −31.812 |
| | 11* | 23.301 | 0.289 | | | |
| L6 | 12* | −23.475 | 0.701 | 1.5348 | 55.7 | f6 = 7.634 |
| | 13* | −3.514 | 0.092 | | | |
| L7 | 14* | −33.105 | 0.994 | 1.6392 | 23.5 | f7 = −56.125 |
| | 15* | −434.186 | 0.492 | | | |
| L8 | 16* | 300.000 | 0.846 | 1.5348 | 55.7 | f8 = −6.572 |
| | 17* | 3.471 | 0.500 | | | |
| | 18 | ∞ | 0.210 | 1.5168 | 64.2 | |
| | 19 | ∞ | 0.807 | | | |
| (IM) | | ∞ | | | | |

f234=−37.327 mm

f67=8.843 mm

R1f=4.489 mm

R1r=−21.600 mm

R6f=−23.475 mm

R6r=−3.514 mm

R8f=300.000 mm

R8r=3.471 mm

D45=0.824 mm

D56=0.289 mm

D78=0.492 mm

TL=9.586 mm

TABLE 12
Aspheric Surface Data:

| i | k | A4 | A6 | A8 | A10 | A12 | A14 | A16 |
|---|---|---|---|---|---|---|---|---|
| 1 | 0.000E+00 | 5.175E−04 | −1.236E−03 | 2.004E−04 | −2.513E−05 | 2.580E−07 | 7.046E−08 | 0.000E+00 |
| 2 | 0.000E+00 | 2.516E−03 | 6.414E−05 | −9.330E−05 | 2.924E−06 | 4.797E−07 | −3.309E−09 | 0.000E+00 |
| 4 | 0.000E+00 | −4.124E−02 | 1.095E−02 | −2.060E−03 | 1.730E−04 | −4.144E−07 | −3.571E−07 | 0.000E+00 |
| 5 | 0.000E+00 | −5.353E−02 | 1.249E−02 | −2.937E−03 | 4.200E−04 | −3.353E−05 | 4.623E−07 | 0.000E+00 |
| 6 | 0.000E+00 | 8.464E−03 | −1.661E−03 | 6.829E−04 | −4.549E−05 | −2.020E−06 | 7.852E−08 | 2.681E−08 |
| 7 | 0.000E+00 | −1.274E−03 | 2.338E−04 | 4.326E−05 | −6.087E−06 | 3.408E−06 | 3.522E−07 | −3.729E−08 |
| 8 | 0.000E+00 | −1.962E−02 | −3.442E−04 | −5.272E−05 | 2.755E−05 | 3.219E−06 | 1.416E−07 | −4.797E−08 |
| 9 | 0.000E+00 | −1.378E−02 | −1.408E−03 | 2.696E−04 | −1.601E−05 | −3.839E−06 | 2.577E−07 | 3.994E−08 |
| 10 | 0.000E+00 | −1.663E−02 | 2.775E−03 | −6.446E−04 | 5.374E−05 | −9.798E−06 | 2.963E−07 | 1.321E−07 |
| 11 | 0.000E+00 | −2.462E−02 | −1.248E−03 | 2.216E−04 | 1.354E−05 | −2.466E−06 | −1.107E−07 | 1.122E−07 |
| 12 | 0.000E+00 | −1.290E−02 | −1.040E−03 | −2.430E−05 | 2.055E−06 | 3.970E−06 | 4.917E−07 | −1.391E−07 |
| 13 | −1.038E+00 | 2.849E−03 | 2.377E−03 | −7.147E−04 | 4.853E−05 | −5.803E−07 | 5.609E−08 | 1.724E−08 |
| 14 | 0.000E+00 | 3.607E−03 | 3.235E−04 | −1.131E−03 | 2.867E−04 | −3.714E−05 | 1.744E−06 | 1.684E−08 |
| 15 | 0.000E+00 | 8.896E−03 | −4.598E−03 | 8.905E−04 | −1.141E−04 | 8.860E−06 | −3.763E−07 | 6.869E−09 |
| 16 | 0.000E+00 | −2.559E−02 | 9.085E−04 | 3.837E−04 | −5.182E−05 | 2.692E−06 | −5.740E−08 | 2.933E−10 |
| 17 | −7.137E+00 | −2.055E−02 | 2.528E−03 | −2.349E−04 | 1.447E−05 | −4.872E−07 | 6.051E−09 | 2.317E−11 |

A value of each conditional expression is described below.

|R1r/R1f|=4.8

f3/f=1.75

f3/f1=1.91

f4/f=−6.10

f4/f=−3.48

f234/f=−4.84

D45/D56=2.9

R6f/R6r=6.7

f2/f6=−1.62

f3/f6=1.77

f7/f=−7.28

f67/f=1.15

R8f/R8r=86.4

f8/f7=0.12

D78/f=0.06

TL/f=1.2

The imaging lens according to Example 6 satisfies the above-described conditional expressions. As shown in FIG. 12, the imaging lens according to Example 6 can also satisfactorily correct aberrations.

### (Second Embodiment)

Referring to the accompanying drawings, an embodiment of the present invention will be described in detail below.

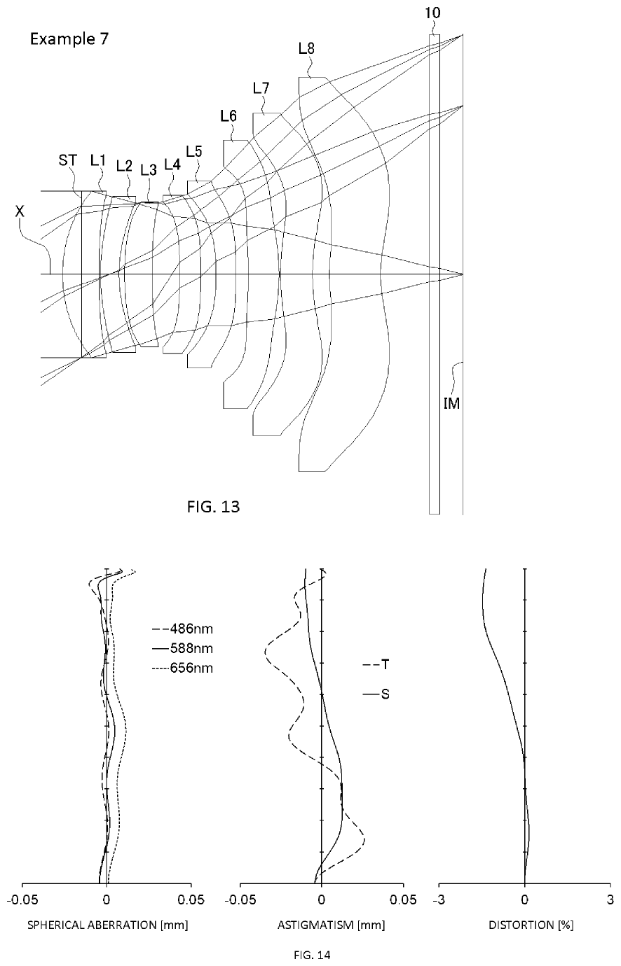

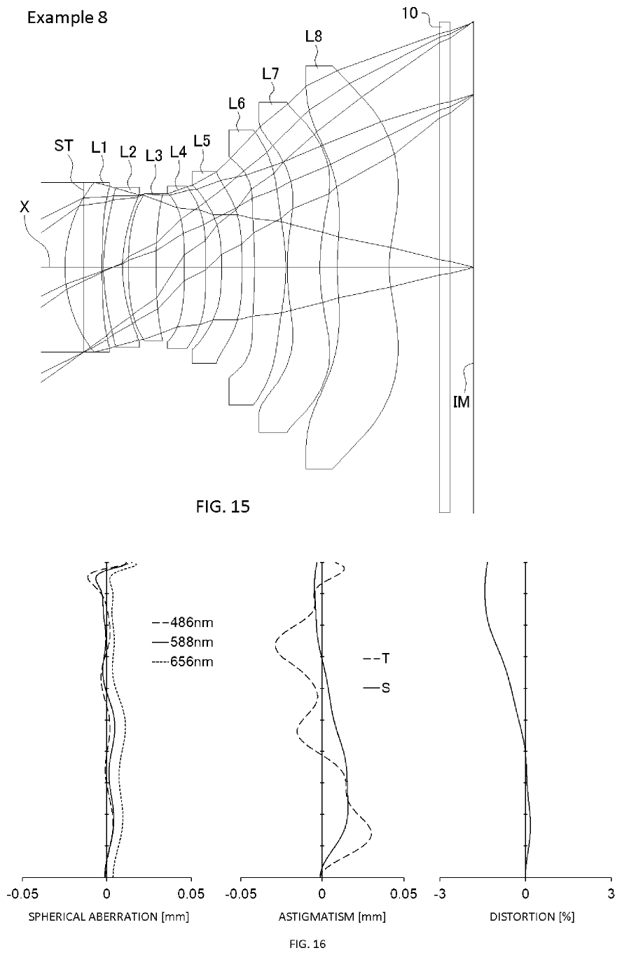

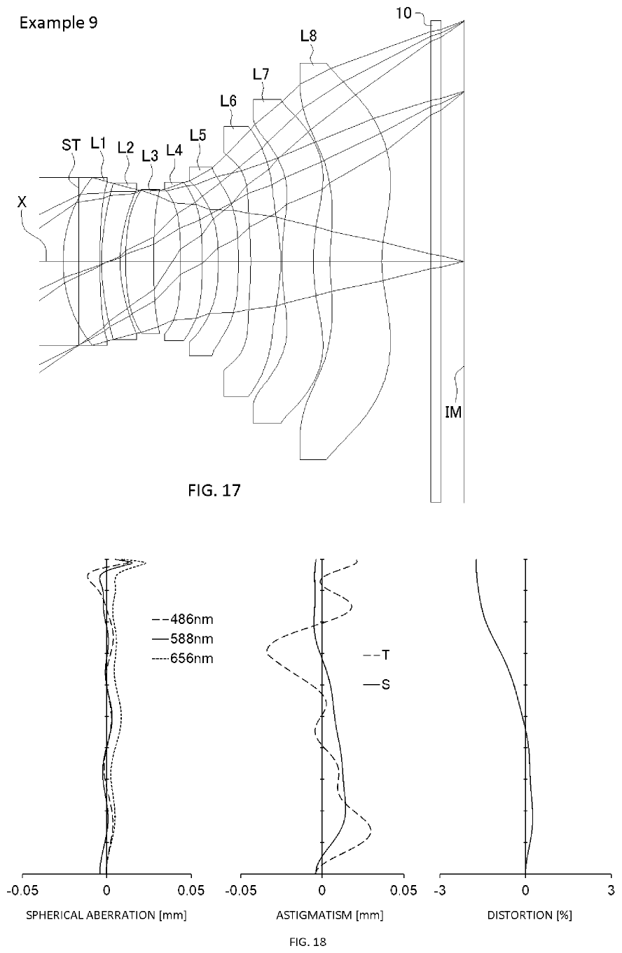

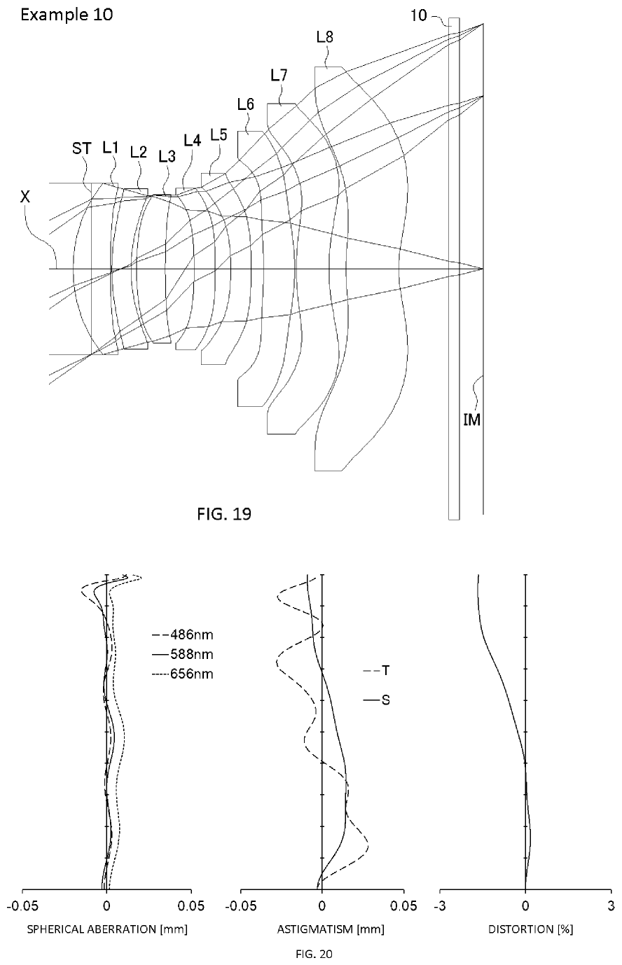

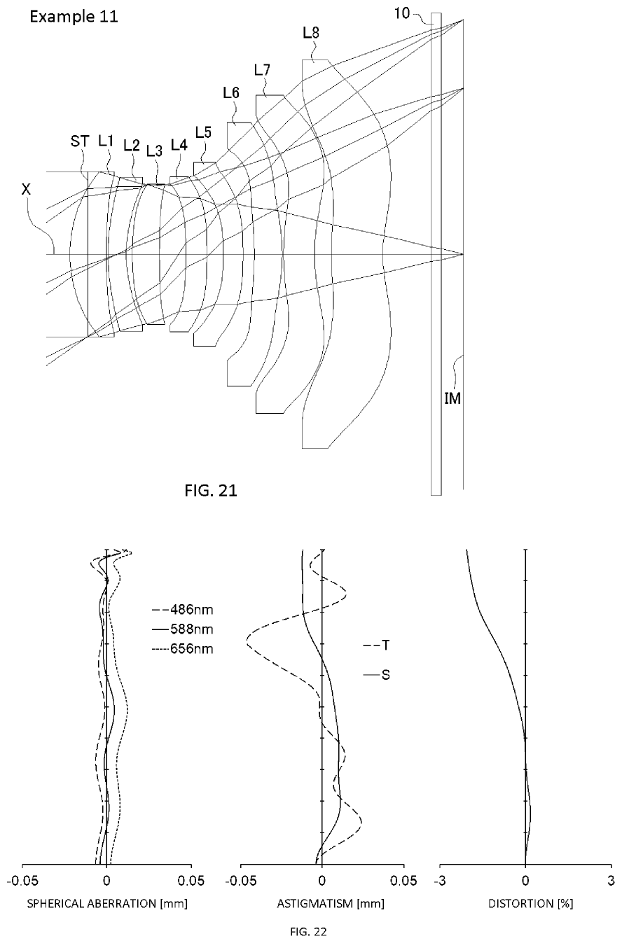

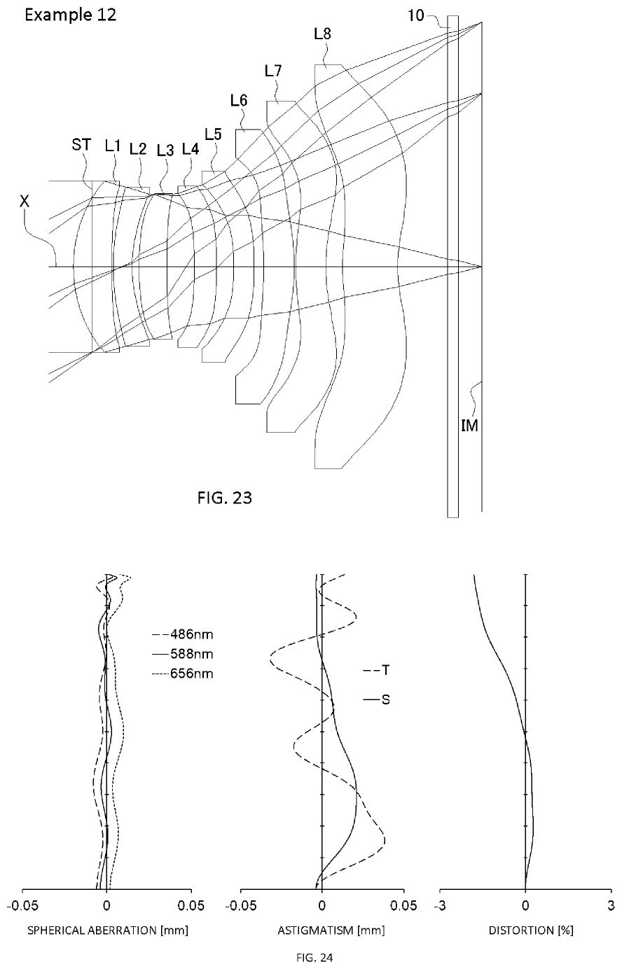

FIGS. 13, 15, 17, 19, 21, and 23 are sectional views illustrating schematic configurations of respective imaging lenses according to Examples 7 through 12 of the present embodiment. Since the imaging lenses in these Examples have the same basic configuration, a description is given here to the lens configuration according to the present embodiment with reference to the illustrative sectional view of Example 7. The imaging lens according to the First Embodiment and the imaging lens according to the Second Embodiment differ in shapes in the paraxial region of the first lens L1, the third lens L3 to the fifth lens L5, and the seventh lens L7. The imaging lens according to the Second Embodiment does not satisfy conditional expressions (13a), (18) and (18a) of the above-described conditional expression (1) to (20), however satisfies remaining conditional expressions. Other basic configurations of the Second Embodiment are common with that of the imaging lens according to the First Embodiment, therefore detail descriptions of such common configurations is omitted.

As illustrated in FIG. 13, the imaging lens according to the present embodiment includes: in order from an object side to an image side, a first lens L1 having positive refractive power; a second lens L2 having negative refractive power; a third lens L3 having positive refractive power; a fourth lens L4 having negative refractive power; a fifth lens L5; a sixth lens L6; a seventh lens L7; and an eighth lens L8 having negative refractive power. Refractive powers of the fifth lens L5 to the seventh lens L7 are not limited to the refractive powers according to the Second Embodiment as well as the imaging lens according to the First Embodiment.

The first lens L1 has a meniscus shape where a curvature radius r2 (=R1f) of an object-side surface and a curvature radius r3 (=R1r) of an image-side surface are both positive, and the object-side surface is convex in a paraxial region. The first lens L1 may have a shape to provide positive refractive power.

In Example 7, an aperture stop ST is arranged on an object side of the first lens L1.

A position of the aperture stop ST is not limited to the position in Example 7 as well as the First Embodiment.

The second lens L2 has a meniscus shape where a curvature radius r4 of an object-side surface and a curvature radius r5 of an image-side surface are both positive, and the object-side surface is convex in a paraxial region. The second lens L2 may have a shape to provide negative refractive power.

The third lens L3 has a meniscus shape where a curvature radius r6 of an object-side surface and a curvature radius r7 of an image-side surface are both positive, and the object-side surface is convex in a paraxial region. The third lens L3 may have a shape to provide positive refractive power.

The fourth lens L4 has a meniscus shape where a curvature radius r8 of an object-side surface and a curvature radius r9 of an image-side surface are both negative, and the object-side surface is concave in a paraxial region. The fourth lens L4 may have a shape to provide negative refractive power.

The fifth lens L5 has negative refractive power. The fifth lens L5 has a meniscus shape where a curvature radius r10 of an object-side surface and a curvature radius r11 of an image-side surface are both negative, and the object-side surface is concave in a paraxial region. The shape of the fifth lens L5 is not limited to the shape according to the Embodiment 7.

The sixth lens L6 has positive refractive power. The sixth lens L6 has a meniscus shape where a curvature radius r12 (=R6f) of an object-side surface and a curvature radius r13 (=R6r) of an image-side surface are both negative, and the object-side surface is concave in a paraxial region. The shape of the sixth lens L6 is not limited to the shape according to the Embodiment 7.

The seventh lens L7 has negative refractive power. The seventh lens L7 has a meniscus shape where a curvature radius r14 of an object-side surface and a curvature radius r15 of an image-side surface are both positive, and the object-side surface is convex in a paraxial region. The shape of the seventh lens L7 is not limited to the shape according to the Embodiment 7.

The eighth lens L8 has a meniscus shape where a curvature radius r16 (=R8f) of an object-side surface and a curvature radius r17 (=R8r) of an image-side surface are both positive, and the object-side surface is convex in a paraxial region. The eighth lens L8 may have a shape to provide negative refractive power.

The image-side surface of the eighth lens L8 is aspheric and provided with at least one inflection point. In the imaging lens according to the present embodiment, both surfaces of the seventh lens L7 and both surfaces of the eighth lens L8 are aspheric surfaces having the at least one inflection point, respectively.

Next, Examples of the imaging lens according to the present embodiment will be described. Herein, an equation expressing aspheric surfaces which is used in the imaging lens according the above First Embodiment is applied to each lens. Furthermore, a meaning which each symbol indicates in each table showing basic lens data is the same as a meaning shown in the First Embodiment.

### EXAMPLE 7

The basic lens data is shown below in Table 13.

TABLE 13
f = 7.05 mm Fno = 2.1 ω = 35.2°

| | i | r | d | n d | νd | [mm] |
|---|---|---|---|---|---|---|
| | | ∞ | ∞ | | | |
| ST | 1 | ∞ | −0.384 | | | |
| L1 | 2* | 2.847 | 0.744 | 1.5445 | 56.4 | f1 = 5.990 |
| | 3* | 20.327 | 0.030 | | | |
| L2 | 4* | 4.122 | 0.377 | 1.6707 | 19.2 | f2 = −12.988 |
| | 5* | 2.695 | 0.114 | | | |
| L3 | 6* | 5.439 | 0.563 | 1.5445 | 56.4 | f3 = 16.778 |
| | 7* | 12.954 | 0.563 | | | |
| L4 | 8* | −16.051 | 0.429 | 1.5445 | 56.4 | f4 = −69.443 |
| | 9* | −28.156 | 0.309 | | | |
| L5 | 10* | −7.296 | 0.409 | 1.6707 | 19.2 | f5 = −14.482 |
| | 11* | −29.974 | 0.253 | | | |
| L6 | 12* | −12.379 | 0.626 | 1.5880 | 28.8 | f6 = 12.490 |
| | 13* | −4.696 | 0.030 | | | |
| L7 | 14* | 4.722 | 0.653 | 1.5348 | 55.7 | f7 = −89.067 |
| | 15* | 4.089 | 0.348 | | | |
| L8 | 16* | 4.205 | 1.041 | 1.5348 | 55.7 | f8 = −14.235 |
| | 17* | 2.475 | 1.000 | | | |
| | 18 | ∞ | 0.210 | 1.5168 | 64.2 | |
| | 19 | ∞ | 0.474 | | | |
| (IM) | | ∞ | | | | |

f234=−29.256 mm

f67=13.678 mm

R1f=2.847 mm

R1r=−20.327 mm

R6f=−12.379 mm

R6r=−4.696 mm

R8f=4.205 mm

R8r=2.475 mm

D45=0.309 mm

D56=0.253 mm

D78=0.348 mm

TL=8.103 mm

TABLE 14
Aspheric Surface Data:

| i | k | A4 | A6 | A8 | A10 |
|---|---|---|---|---|---|
| 2 | −7.111E−01 | 4.176E−03 | 1.190E−02 | −3.062E−02 | 4.389E−02 |
| 3 | 0.000E+00 | 1.485E−02 | −1.460E−02 | 2.900E−02 | −2.855E−02 |
| 4 | −7.471E−01 | −1.737E−02 | −9.390E−03 | 3.451E−02 | −3.859E−02 |
| 5 | −2.113E+00 | −2.447E−02 | −3.367E−03 | 4.835E−02 | −6.736E−02 |
| 6 | 0.000E+00 | 8.283E−03 | −9.130E−03 | 6.430E−02 | −1.031E−01 |
| 7 | 0.000E+00 | −3.327E−03 | 3.008E−02 | −5.958E−02 | 8.905E−02 |
| 8 | 0.000E+00 | −5.083E−02 | 1.154E−02 | −3.421E−03 | −3.720E−02 |
| 9 | 0.000E+00 | −6.965E−02 | 1.340E−02 | 1.952E−02 | −7.250E−02 |
| 10 | 0.000E+00 | −1.223E−01 | 9.739E−02 | −1.129E−01 | 8.251E−02 |
| 11 | 0.000E+00 | −1.295E−01 | 1.538E−01 | −1.682E−01 | 1.190E−01 |
| 12 | 0.000E+00 | −6.073E−02 | 1.576E−01 | −1.525E−01 | 8.662E−02 |
| 13 | −1.485E−01 | −2.471E−02 | 4.456E−02 | −1.355E−02 | −2.207E−03 |
| 14 | −3.167E−01 | −1.829E−03 | −3.102E−02 | 2.064E−02 | −9.755E−03 |
| 15 | −1.425E−01 | −1.122E−02 | −5.381E−03 | 1.672E−03 | −6.521E−04 |
| 16 | −2.971E−01 | −1.174E−01 | 5.479E−02 | −1.769E−02 | 3.590E−03 |
| 17 | −7.596E+00 | −5.327E−02 | 2.020E−02 | −6.027E−03 | 1.209E−03 |
| i | A12 | A14 | A16 | A18 | A20 |
| 2 | −3.704E−02 | 1.913E−02 | −5.948E−03 | 1.023E−03 | −7.503E−05 |
| 3 | 1.353E−02 | −1.334E−03 | −1.422E−03 | 5.780E−04 | −6.896E−05 |
| 4 | 1.867E−02 | −8.648E−04 | −2.876E−03 | 1.108E−03 | −1.320E−04 |
| 5 | 3.930E−02 | −2.152E−03 | −8.595E−03 | 3.846E−03 | −5.234E−04 |
| 6 | 9.295E−02 | −4.884E−02 | 1.460E−02 | −2.286E−03 | 1.458E−04 |
| 7 | −8.667E−02 | 5.371E−02 | −2.007E−02 | 4.047E−03 | −3.385E−04 |
| 8 | 7.871E−02 | −7.983E−02 | 4.466E−02 | −1.314E−02 | 1.578E−03 |
| 9 | 1.021E−01 | −7.923E−02 | 3.530E−02 | −8.414E−03 | 8.290E−04 |
| 10 | −1.774E−02 | −1.663E−02 | 1.348E−02 | −3.820E−03 | 3.922E−04 |
| 11 | −5.376E−02 | 1.513E−02 | −2.453E−03 | 1.891E−04 | −3.357E−06 |
| 12 | −3.243E−02 | 7.961E−03 | −1.217E−03 | 1.036E−04 | −3.678E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.890E−08 |
| 15 | 1.875E−04 | −3.053E−05 | 2.773E−06 | −1.331E−07 | 2.662E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=7.1

f3/f=2.38

f3/f1=2.80

f4/f=−9.86

f4/f=−4.14

f234/f=−4.15

D45/D56=1.2

R6f/R6r=2.6

f2/f6=−1.04

f3/f6=1.34

f7/f=−12.64

f67/f=1.94

R8f/R8r=1.7

f8/f7=0.16

D78/f=0.05

TL/f=1.2

The imaging lens according to Example 7 satisfies the above-described conditional expressions. As shown in FIG. 14, the imaging lens according to Example 7 can satisfactorily correct aberrations.

### EXAMPLE 8

The basic lens data is shown below in Table 15.

TABLE 15
f = 7.05 mm Fno = 2.1 ω = 35.2°

| | i | r | d | n d | νd | [mm] |
|---|---|---|---|---|---|---|
| | | ∞ | ∞ | | | |
| ST | 1 | ∞ | −0.374 | | | |
| L1 | 2* | 2.851 | 0.744 | 1.5445 | 56.4 | f1 = 5.998 |
| | 3* | 20.357 | 0.030 | | | |
| L2 | 4* | 4.129 | 0.378 | 1.6707 | 19.2 | f2 = −12.932 |
| | 5* | 2.695 | 0.114 | | | |
| L3 | 6* | 5.421 | 0.560 | 1.5445 | 56.4 | f3 = 16.821 |
| | 7* | 12.800 | 0.564 | | | |
| L4 | 8* | −16.401 | 0.431 | 1.5445 | 56.4 | f4 = −81.275 |
| | 9* | −26.301 | 0.314 | | | |
| L5 | 10* | −7.180 | 0.408 | 1.6707 | 19.2 | f5 = −14.327 |
| | 11* | −29.040 | 0.252 | | | |
| L6 | 12* | −12.268 | 0.622 | 1.5880 | 28.8 | f6 = 12.522 |
| | 13* | −4.688 | 0.030 | | | |
| L7 | 14* | 4.754 | 0.651 | 1.5348 | 55.7 | f7 = −85.012 |
| | 15* | 4.098 | 0.347 | | | |
| L8 | 16* | 4.206 | 1.043 | 1.5348 | 55.7 | f8 = −14.352 |
| | 17* | 2.483 | 1.000 | | | |
| | 18 | ∞ | 0.210 | 1.5168 | 64.2 | |
| | 19 | ∞ | 0.475 | | | |
| (IM) | | ∞ | | | | |

f234=−30.650 mm

f67=13.826 mm

R1f=2.851 mm

R1r=−20.357 mm

R6f=−12.268 mm

R6r=−4.688 mm

R8f=4.206 mm

R8r=2.483 mm

D45=0.314 mm

D56=0.252 mm

D78=0.347 mm

TL=8.103 mm

TABLE 16
Aspheric Surface Data:

| i | k | A4 | A6 | A8 | A10 |
|---|---|---|---|---|---|
| 2 | −7.139E−01 | 4.159E−03 | 1.189E−02 | −3.062E−02 | 4.390E−02 |
| 3 | 0.000E+00 | 1.482E−02 | −1.460E−02 | 2.901E−02 | −2.855E−02 |
| 4 | −7.378E−01 | −1.736E−02 | −9.395E−03 | 3.450E−02 | −3.859E−02 |
| 5 | −2.120E+00 | −2.449E−02 | −3.367E−03 | 4.834E−02 | −6.736E−02 |
| 6 | 0.000E+00 | 8.272E−03 | −9.137E−03 | 6.430E−02 | −1.031E−01 |
| 7 | 0.000E+00 | −3.270E−03 | 3.008E−02 | −5.958E−02 | 8.905E−02 |
| 8 | 0.000E+00 | −5.076E−02 | 1.157E−02 | −3.424E−03 | −3.720E−02 |
| 9 | 0.000E+00 | −6.962E−02 | 1.339E−02 | 1.951E−02 | −7.250E−02 |
| 10 | 0.000E+00 | −1.224E−01 | 9.738E−02 | −1.129E−01 | 8.251E−02 |
| 11 | 0.000E+00 | −1.295E−01 | 1.538E−01 | −1.682E−01 | 1.190E−01 |
| 12 | 0.000E+00 | −6.079E−02 | 1.576E−01 | −1.525E−01 | 8.662E−02 |
| 13 | −1.432E−01 | −2.472E−02 | 4.457E−02 | −1.355E−02 | −2.207E−03 |
| 14 | −2.828E−01 | −1.759E−03 | −3.102E−02 | 2.064E−02 | −9.755E−03 |
| 15 | −1.370E−01 | −1.117E−02 | −5.378E−03 | 1.672E−03 | −6.521E−04 |
| 16 | −2.976E−01 | −1.174E−01 | 5.479E−02 | −1.769E−02 | 3.590E−03 |
| 17 | −7.605E+00 | −5.325E−02 | 2.020E−02 | −6.027E−03 | 1.209E−03 |
| i | A12 | A14 | A16 | A18 | A20 |
| 2 | −3.704E−02 | 1.914E−02 | −5.948E−03 | 1.023E−03 | −7.502E−05 |
| 3 | 1.353E−02 | −1.334E−03 | −1.422E−03 | 5.780E−04 | −6.898E−05 |
| 4 | 1.867E−02 | −8.650E−04 | −2.876E−03 | 1.108E−03 | −1.320E−04 |
| 5 | 3.930E−02 | −2.153E−03 | −8.595E−03 | 3.846E−03 | −5.234E−04 |
| 6 | 9.295E−02 | −4.884E−02 | 1.460E−02 | −2.286E−03 | 1.457E−04 |
| 7 | −8.667E−02 | 5.371E−02 | −2.007E−02 | 4.047E−03 | −3.385E−04 |
| 8 | 7.871E−02 | −7.983E−02 | 4.466E−02 | −1.314E−02 | 1.578E−03 |
| 9 | 1.021E−01 | −7.923E−02 | 3.530E−02 | −8.414E−03 | 8.290E−04 |
| 10 | −1.774E−02 | −1.663E−02 | 1.348E−02 | −3.819E−03 | 3.922E−04 |
| 11 | −5.376E−02 | 1.513E−02 | −2.453E−03 | 1.891E−04 | −3.358E−06 |
| 12 | −3.243E−02 | 7.961E−03 | −1.217E−03 | 1.036E−04 | −3.679E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.890E−08 |
| 15 | 1.875E−04 | −3.053E−05 | 2.773E−06 | −1.331E−07 | 2.662E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=7.1

f3/f=2.39

f3/f1=2.80

f4/f=−11.53

f4/f=−4.83

f234/f=−4.35

D45/D56=1.2

R6f/R6r=2.6

f2/f6=−1.03

f3/f6=1.34

f7/f=−12.06

f67/f=1.96

R8f/R8r=1.7

f8/f7=0.17

D78/f=0.05

TL/f=1.1

The imaging lens according to Example 8 satisfies the above-described conditional expressions. As shown in FIG. 16, the imaging lens according to Example 8 can also satisfactorily correct aberrations.

### EXAMPLE 9

The basic lens data is shown below in Table 17.

TABLE 17
f = 7.07 mm Fno = 2.1 ω = 35.1°

| | i | r | d | n d | νd | [mm] |
|---|---|---|---|---|---|---|
| | | ∞ | ∞ | | | |
| ST | 1 | ∞ | −0.314 | | | |
| L1 | 2* | 2.830 | 0.751 | 1.5445 | 56.4 | f1 = 5.921 |
| | 3* | 20.981 | 0.030 | | | |
| L2 | 4* | 4.231 | 0.379 | 1.6707 | 19.2 | f2 = −12.018 |
| | 5* | 2.675 | 0.113 | | | |
| L3 | 6* | 5.283 | 0.568 | 1.5445 | 56.4 | f3 = 15.551 |
| | 7* | 13.516 | 0.555 | | | |
| L4 | 8* | −14.508 | 0.438 | 1.5445 | 56.4 | f4 = −74.922 |
| | 9* | −22.756 | 0.327 | | | |
| L5 | 10* | −7.347 | 0.408 | 1.6707 | 19.2 | f5 = −17.239 |
| | 11* | −20.601 | 0.251 | | | |
| L6 | 12* | −10.449 | 0.606 | 1.5880 | 28.8 | f6 = 14.884 |
| | 13* | −4.865 | 0.030 | | | |
| L7 | 14* | 4.867 | 0.642 | 1.5348 | 55.7 | f7 = −71.067 |
| | 15* | 4.116 | 0.342 | | | |
| L8 | 16* | 4.203 | 1.053 | 1.5348 | 55.7 | f8 = −15.082 |
| | 17* | 2.522 | 1.000 | | | |
| | 18 | ∞ | 0.210 | 1.5168 | 64.2 | |
| | 19 | ∞ | 0.472 | | | |
| (IM) | | ∞ | | | | |

f234=−28.762 mm

f67=17.702 mm

R1f=2.830 mm

R1r=−20.981 mm

R6f=−10.449 mm

R6r=−4.865 mm

R8f=4.203 mm

R8r=2.522 mm

D45=0.327 mm

D56=0.251 mm

D78=0.342 mm

TL=8.101 mm

TABLE 18
Aspheric Surface Data:

| i | k | A4 | A6 | A8 | A10 |
|---|---|---|---|---|---|
| 2 | −7.384E−01 | 4.007E−03 | 1.185E−02 | −3.063E−02 | 4.390E−02 |
| 3 | 0.000E+00 | 1.490E−02 | −1.458E−02 | 2.901E−02 | −2.855E−02 |
| 4 | −6.707E−01 | −1.724E−02 | −9.345E−03 | 3.453E−02 | −3.858E−02 |
| 5 | −2.136E+00 | −2.458E−02 | −3.414E−03 | 4.832E−02 | −6.737E−02 |
| 6 | 0.000E+00 | 8.020E−03 | −9.153E−03 | 6.431E−02 | −1.031E−01 |
| 7 | 0.000E+00 | −3.101E−03 | 3.003E−02 | −5.956E−02 | 8.909E−02 |
| 8 | 0.000E+00 | −5.027E−02 | 1.175E−02 | −3.441E−03 | −3.722E−02 |
| 9 | 0.000E+00 | −6.920E−02 | 1.361E−02 | 1.957E−02 | −7.249E−02 |
| 10 | 0.000E+00 | −1.228E−01 | 9.714E−02 | −1.129E−01 | 8.252E−02 |
| 11 | 0.000E+00 | −1.290E−01 | 1.538E−01 | −1.682E−01 | 1.190E−01 |
| 12 | 0.000E+00 | −5.993E−02 | 1.577E−01 | −1.525E−01 | 8.661E−02 |
| 13 | 3.337E−02 | −2.510E−02 | 4.454E−02 | −1.355E−02 | −2.207E−03 |
| 14 | −2.650E−01 | −1.747E−03 | −3.101E−02 | 2.064E−02 | −9.755E−03 |
| 15 | −1.363E−01 | −1.112E−02 | −5.383E−03 | 1.671E−03 | −6.521E−04 |
| 16 | −2.979E−01 | −1.175E−01 | 5.479E−02 | −1.769E−02 | 3.590E−03 |
| 17 | −7.507E+00 | −5.331E−02 | 2.020E−02 | −6.027E−03 | 1.209E−03 |
| i | A12 | A14 | A16 | A18 | A20 |
| 2 | −3.704E−02 | 1.914E−02 | −5.948E−03 | 1.023E−03 | −7.503E−05 |
| 3 | 1.353E−02 | −1.333E−03 | −1.421E−03 | 5.780E−04 | −6.909E−05 |
| 4 | 1.867E−02 | −8.655E−04 | −2.876E−03 | 1.108E−03 | −1.320E−04 |
| 5 | 3.930E−02 | −2.154E−03 | −8.596E−03 | 3.846E−03 | −5.235E−04 |
| 6 | 9.296E−02 | −4.884E−02 | 1.460E−02 | −2.285E−03 | 1.457E−04 |
| 7 | −8.665E−02 | 5.371E−02 | −2.007E−02 | 4.047E−03 | −3.382E−04 |
| 8 | 7.871E−02 | −7.982E−02 | 4.466E−02 | −1.314E−02 | 1.577E−03 |
| 9 | 1.021E−01 | −7.923E−02 | 3.530E−02 | −8.414E−03 | 8.291E−04 |
| 10 | −1.774E−02 | −1.663E−02 | 1.348E−02 | −3.820E−03 | 3.922E−04 |
| 11 | −5.376E−02 | 1.513E−02 | −2.453E−03 | 1.891E−04 | −3.358E−06 |
| 12 | −3.243E−02 | 7.961E−03 | −1.217E−03 | 1.036E−04 | −3.677E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.890E−08 |
| 15 | 1.875E−04 | −3.053E−05 | 2.773E−06 | −1.331E−07 | 2.663E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=7.4

f3/f=2.20

f3/f1=2.63

f4/f=−10.59

f4/f=−4.82

f234/f=−4.07

D45/D56=1.3

R6f/R6r=2.1

f2/f6=−0.81

f3/f6=1.04

f7/f=−10.05

f67/f=2.50

R8f/R8r=1.7

f8/f7=0.21

D78/f=0.05

TL/f=1.1

The imaging lens according to Example 9 satisfies the above-described conditional expressions. As shown in FIG. 18, the imaging lens according to Example 9 can also satisfactorily correct aberrations.

### EXAMPLE 10

The basic lens data is shown below in Table 19.

TABLE 19
f = 7.07 mm Fno = 2.1 ω = 35.1°

| | i | r | d | n d | νd | [mm] |
|---|---|---|---|---|---|---|
| | | ∞ | ∞ | | | |
| ST | 1 | ∞ | −0.362 | | | |
| L1 | 2* | 2.835 | 0.744 | 1.5445 | 56.4 | f1 = 6.025 |
| | 3* | 18.955 | 0.030 | | | |
| L2 | 4* | 4.143 | 0.377 | 1.6707 | 19.2 | f2 = −12.739 |
| | 5* | 2.688 | 0.111 | | | |
| L3 | 6* | 5.369 | 0.574 | 1.5445 | 56.4 | f3 = 15.089 |
| | 7* | 14.911 | 0.573 | | | |
| L4 | 8* | −11.599 | 0.423 | 1.5445 | 56.4 | f4 = −66.209 |
| | 9* | −17.323 | 0.308 | | | |
| L5 | 10* | −7.182 | 0.408 | 1.6707 | 19.2 | f5 = −15.075 |
| | 11* | −25.353 | 0.247 | | | |
| L6 | 12* | −11.468 | 0.622 | 1.5880 | 28.8 | f6 = 13.711 |
| | 13* | −4.829 | 0.030 | | | |
| L7 | 14* | 4.805 | 0.652 | 1.5348 | 55.7 | f7 = −81.991 |
| | 15* | 4.126 | 0.340 | | | |
| L8 | 16* | 4.207 | 1.050 | 1.5348 | 55.7 | f8 = −14.567 |
| | 17* | 2.494 | 1.000 | | | |
| | 18 | ∞ | 0.210 | 1.5168 | 64.2 | |
| | 19 | ∞ | 0.473 | | | |
| (IM) | | ∞ | | | | |

f234=−33.659 mm

f67=15.495 mm

R1f=2.835 mm

R1r=−18.955 mm

R6f=−11.468 mm

R6r=−4.829 mm

R8f=4.207 mm

R8r=2.494 mm

D45=0.308 mm

D56=0.247 mm

D78=0.340 mm

TL=8.101 mm

TABLE 20
Aspheric Surface Data:

| i | k | A4 | A6 | A8 | A10 |
|---|---|---|---|---|---|
| 2 | −7.240E−01 | 4.097E−03 | 1.187E−02 | −3.063E−02 | 4.389E−02 |
| 3 | 0.000E+00 | 1.485E−02 | −1.459E−02 | 2.901E−02 | −2.855E−02 |
| 4 | −7.366E−01 | −1.735E−02 | −9.389E−03 | 3.451E−02 | −3.858E−02 |
| 5 | −2.126E+00 | −2.453E−02 | −3.392E−03 | 4.833E−02 | −6.737E−02 |
| 6 | 0.000E+00 | 8.239E−03 | −9.137E−03 | 6.430E−02 | −1.031E−01 |
| 7 | 0.000E+00 | −3.334E−03 | 2.998E−02 | −5.961E−02 | 8.905E−02 |
| 8 | 0.000E+00 | −5.057E−02 | 1.158E−02 | −3.436E−03 | −3.720E−02 |
| 9 | 0.000E+00 | −6.943E−02 | 1.355E−02 | 1.956E−02 | −7.249E−02 |
| 10 | 0.000E+00 | −1.226E−01 | 9.723E−02 | −1.129E−01 | 8.251E−02 |
| 11 | 0.000E+00 | −1.293E−01 | 1.538E−01 | −1.682E−01 | 1.190E−01 |
| 12 | 0.000E+00 | −6.050E−02 | 1.577E−01 | −1.525E−01 | 8.662E−02 |
| 13 | −8.300E−02 | −2.483E−02 | 4.455E−02 | −1.355E−02 | −2.207E−03 |
| 14 | −3.117E−01 | −1.818E−03 | −3.102E−02 | 2.064E−02 | −9.755E−03 |
| 15 | −1.387E−01 | −1.119E−02 | −5.380E−03 | 1.672E−03 | −6.521E−04 |
| 16 | −2.971E−01 | −1.174E−01 | 5.479E−02 | −1.769E−02 | 3.590E−03 |
| 17 | −7.566E+00 | −5.331E−02 | 2.020E−02 | −6.027E−03 | 1.209E−03 |
| i | A12 | A14 | A16 | A18 | A20 |
| 2 | −3.704E−02 | 1.913E−02 | −5.948E−03 | 1.023E−03 | −7.503E−05 |
| 3 | 1.353E−02 | −1.334E−03 | −1.422E−03 | 5.780E−04 | −6.900E−05 |
| 4 | 1.867E−02 | −8.648E−04 | −2.876E−03 | 1.108E−03 | −1.321E−04 |
| 5 | 3.930E−02 | −2.154E−03 | −8.596E−03 | 3.846E−03 | −5.233E−04 |
| 6 | 9.295E−02 | −4.884E−02 | 1.460E−02 | −2.286E−03 | 1.457E−04 |
| 7 | −8.667E−02 | 5.371E−02 | −2.007E−02 | 4.047E−03 | −3.384E−04 |
| 8 | 7.871E−02 | −7.983E−02 | 4.466E−02 | −1.314E−02 | 1.578E−03 |
| 9 | 1.021E−01 | −7.923E−02 | 3.530E−02 | −8.414E−03 | 8.291E−04 |
| 10 | −1.774E−02 | −1.663E−02 | 1.348E−02 | −3.820E−03 | 3.922E−04 |
| 11 | −5.376E−02 | 1.513E−02 | −2.452E−03 | 1.891E−04 | −3.354E−06 |
| 12 | −3.243E−02 | 7.961E−03 | −1.217E−03 | 1.036E−04 | −3.678E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.890E−08 |
| 15 | 1.875E−04 | −3.053E−05 | 2.773E−06 | −1.331E−07 | 2.662E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=6.7

f3/f=2.13

f3/f1=2.50

f4/f=−9.36

f4/f=−4.39

f234/f=−4.76

D45/D56=1.2

R6f/R6r=2.4

f2/f6=−0.93

f3/f6=1.10

f7/f=−11.60

f67/f=2.19

R8f/R8r=1.7

f8/f7=0.18

D78/f=0.05

TL/f=1.1

The imaging lens according to Example 10 satisfies the above-described conditional expressions. As shown in FIG. 20, the imaging lens according to Example 10 can also satisfactorily correct aberrations.

### EXAMPLE 11

The basic lens data is shown below in Table 21.

TABLE 21
f = 7.10 mm Fno = 2.1 ω = 35.0°

| | i | r | d | n d | νd | [mm] |
|---|---|---|---|---|---|---|
| | | ∞ | ∞ | | | |
| ST | 1 | ∞ | −0.369 | | | |
| L1 | 2* | 2.801 | 0.761 | 1.5445 | 56.4 | f1 = 5.933 |
| | 3* | 19.032 | 0.030 | | | |
| L2 | 4* | 4.097 | 0.378 | 1.6707 | 19.2 | f2 = −12.670 |
| | 5* | 2.662 | 0.129 | | | |
| L3 | 6* | 5.674 | 0.559 | 1.5445 | 56.4 | f3 = 16.309 |
| | 7* | 15.171 | 0.551 | | | |
| L4 | 8* | −13.436 | 0.435 | 1.5445 | 56.4 | f4 = −76.944 |
| | 9* | −20.006 | 0.342 | | | |
| L5 | 10* | −6.700 | 0.408 | 1.6707 | 19.2 | f5 = −20.251 |
| | 11* | −13.544 | 0.236 | | | |
| L6 | 12* | −7.744 | 0.578 | 1.5880 | 28.8 | f6 = 17.582 |
| | 13* | −4.550 | 0.030 | | | |
| L7 | 14* | 4.934 | 0.645 | 1.5348 | 55.7 | f7 = −60.376 |
| | 15* | 4.086 | 0.345 | | | |
| L8 | 16* | 4.188 | 1.070 | 1.5348 | 55.7 | f8 = −15.891 |
| | 17* | 2.556 | 1.000 | | | |
| | 18 | ∞ | 0.210 | 1.5168 | 64.2 | |
| | 19 | ∞ | 0.467 | | | |
| (IM) | | ∞ | | | | |

f234=−30.437 mm

f67=23.250 mm

R1f=2.801 mm

R1r=−19.032 mm

R6f=−7.744 mm

R6r=−4.550 mm

R8f=4.188 mm

R8r=2.556 mm

D45=0.342 mm

D56=0.236 mm

D78=0.345 mm

TL=8.103 mm

TABLE 22
Aspheric Surface Data:

| i | k | A4 | A6 | A8 | A10 |
|---|---|---|---|---|---|
| 2 | −7.041E−01 | 4.233E−03 | 1.187E−02 | −3.063E−02 | 4.390E−02 |
| 3 | 0.000E+00 | 1.458E−02 | −1.464E−02 | 2.901E−02 | −2.855E−02 |
| 4 | −7.220E−01 | −1.732E−02 | −9.403E−03 | 3.451E−02 | −3.858E−02 |
| 5 | −2.044E+00 | −2.413E−02 | −3.214E−03 | 4.839E−02 | −6.735E−02 |
| 6 | 0.000E+00 | 8.209E−03 | −9.012E−03 | 6.440E−02 | −1.031E−01 |
| 7 | 0.000E+00 | −3.004E−03 | 2.984E−02 | −5.965E−02 | 8.907E−02 |
| 8 | 0.000E+00 | −5.000E−02 | 1.179E−02 | −3.515E−03 | −3.726E−02 |
| 9 | 0.000E+00 | −6.893E−02 | 1.346E−02 | 1.945E−02 | −7.251E−02 |
| 10 | 0.000E+00 | −1.244E−01 | 9.676E−02 | −1.129E−01 | 8.256E−02 |
| 11 | 0.000E+00 | −1.287E−01 | 1.538E−01 | −1.682E−01 | 1.190E−01 |
| 12 | 0.000E+00 | −5.673E−02 | 1.575E−01 | −1.526E−01 | 8.661E−02 |
| 13 | −2.113E−01 | −2.450E−02 | 4.454E−02 | −1.355E−02 | −2.207E−03 |
| 14 | −1.922E−01 | −1.610E−03 | −3.099E−02 | 2.064E−02 | −9.755E−03 |
| 15 | −1.291E−01 | −1.106E−02 | −5.391E−03 | 1.672E−03 | −6.520E−04 |
| 16 | −2.995E−01 | −1.174E−01 | 5.479E−02 | −1.769E−02 | 3.590E−03 |
| 17 | −7.762E+00 | −5.328E−02 | 2.019E−02 | −6.027E−03 | 1.209E−03 |
| i | A12 | A14 | A16 | A18 | A20 |
| 2 | −3.703E−02 | 1.914E−02 | −5.948E−03 | 1.023E−03 | −7.502E−05 |
| 3 | 1.354E−02 | −1.331E−03 | −1.421E−03 | 5.781E−04 | −6.916E−05 |
| 4 | 1.867E−02 | −8.648E−04 | −2.876E−03 | 1.108E−03 | −1.320E−04 |
| 5 | 3.930E−02 | −2.152E−03 | −8.595E−03 | 3.846E−03 | −5.239E−04 |
| 6 | 9.297E−02 | −4.884E−02 | 1.460E−02 | −2.286E−03 | 1.456E−04 |
| 7 | −8.665E−02 | 5.372E−02 | −2.007E−02 | 4.047E−03 | −3.381E−04 |
| 8 | 7.870E−02 | −7.982E−02 | 4.467E−02 | −1.313E−02 | 1.577E−03 |
| 9 | 1.021E−01 | −7.923E−02 | 3.530E−02 | −8.414E−03 | 8.293E−04 |
| 10 | −1.773E−02 | −1.664E−02 | 1.348E−02 | −3.820E−03 | 3.924E−04 |
| 11 | −5.376E−02 | 1.513E−02 | −2.452E−03 | 1.891E−04 | −3.365E−06 |
| 12 | −3.243E−02 | 7.961E−03 | −1.217E−03 | 1.036E−04 | −3.678E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.889E−08 |
| 15 | 1.875E−04 | −3.053E−05 | 2.773E−06 | −1.331E−07 | 2.662E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=6.8

f3/f=2.30

f3/f1=2.75

f4/f=−10.84

f4/f=−4.72

f234/f=−4.29

D45/D56=1.4

R6f/R6r=1.7

f2/f6=−0.72

f3/f6=0.93

f7/f=−8.50

f67/f=3.27

R8f/R8r=1.6

f8/f7=0.26

D78/f=0.05

TL/f=1.1

The imaging lens according to Example 11 satisfies the above-described conditional expressions. As shown in FIG. 22, the imaging lens according to Example 11 can also satisfactorily correct aberrations.

### EXAMPLE 12

The basic lens data is shown below in Table 23.

TABLE 23
f = 7.08 mm Fno = 2.1 ω = 35.1°

| | i | r | d | n d | νd | [mm] |
|---|---|---|---|---|---|---|
| | | ∞ | ∞ | | | |
| ST | 1 | ∞ | −0.373 | | | |
| L1 | 2* | 2.763 | 0.766 | 1.5445 | 56.4 | f1 = 5.920 |
| | 3* | 17.445 | 0.030 | | | |
| L2 | 4* | 4.043 | 0.379 | 1.6707 | 19.2 | f2 = −12.771 |
| | 5* | 2.643 | 0.138 | | | |
| L3 | 6* | 5.904 | 0.557 | 1.5445 | 56.4 | f3 = 15.681 |
| | 7* | 18.508 | 0.550 | | | |
| L4 | 8* | −12.965 | 0.441 | 1.5445 | 56.4 | f4 = −70.694 |
| | 9* | −19.785 | 0.347 | | | |
| L5 | 10* | −5.524 | 0.408 | 1.6707 | 19.2 | f5 = −16.900 |
| | 11* | −11.096 | 0.189 | | | |
| L6 | 12* | −10.682 | 0.613 | 1.5880 | 28.8 | f6 = 15.164 |
| | 13* | −4.963 | 0.030 | | | |
| L7 | 14* | 5.206 | 0.603 | 1.5348 | 55.7 | f7 = −34.363 |
| | 15* | 3.893 | 0.334 | | | |
| L8 | 16* | 3.827 | 1.102 | 1.5348 | 55.7 | f8 = −20.999 |
| | 17* | 2.568 | 1.000 | | | |
| | 18 | ∞ | 0.210 | 1.5168 | 64.2 | |
| | 19 | ∞ | 0.479 | | | |
| (IM) | | ∞ | | | | |

f234=−32.489 mm

f67=25.099 mm

R1f=2.763 mm

R1r=−17.445 mm

R6f=−10.682 mm

R6r=−4.963 mm

R8f=3.827 mm

R8r=2.568 mm

D45=0.347 mm

D56=0.189 mm

D78=0.334 mm

TL=8.104 mm

TABLE 24
Aspheric Surface Data:

| i | k | A4 | A6 | A8 | A10 |
|---|---|---|---|---|---|
| 2 | −6.734E−01 | 4.440E−03 | 1.185E−02 | −3.063E−02 | 4.390E−02 |
| 3 | 0.000E+00 | 1.446E−02 | −1.465E−02 | 2.900E−02 | −2.855E−02 |
| 4 | −7.432E−01 | −1.735E−02 | −9.473E−03 | 3.449E−02 | −3.859E−02 |
| 5 | −2.010E+00 | −2.393E−02 | −3.126E−03 | 4.837E−02 | −6.737E−02 |
| 6 | 0.000E+00 | 8.485E−03 | −8.943E−03 | 6.453E−02 | −1.030E−01 |
| 7 | 0.000E+00 | −3.356E−03 | 3.028E−02 | −5.953E−02 | 8.908E−02 |
| 8 | 0.000E+00 | −5.101E−02 | 1.146E−02 | −3.407E−03 | −3.728E−02 |
| 9 | 0.000E+00 | −6.921E−02 | 1.343E−02 | 1.940E−02 | −7.254E−02 |
| 10 | 0.000E+00 | −1.216E−01 | 9.760E−02 | −1.128E−01 | 8.253E−02 |
| 11 | 0.000E+00 | −1.288E−01 | 1.541E−01 | −1.682E−01 | 1.190E−01 |
| 12 | 0.000E+00 | −6.355E−02 | 1.575E−01 | −1.525E−01 | 8.662E−02 |
| 13 | 4.012E−01 | −2.650E−02 | 4.466E−02 | −1.354E−02 | −2.207E−03 |
| 14 | 1.814E−01 | −4.398E−04 | −3.106E−02 | 2.064E−02 | −9.755E−03 |
| 15 | −1.817E−01 | −1.208E−02 | −5.339E−03 | 1.672E−03 | −6.521E−04 |
| 16 | −3.643E−01 | −1.180E−01 | 5.477E−02 | −1.769E−02 | 3.590E−03 |
| 17 | −7.255E+00 | −5.349E−02 | 2.021E−02 | −6.026E−03 | 1.209E−03 |
| i | A12 | A14 | A16 | A18 | A20 |
| 2 | −3.703E−02 | 1.914E−02 | −5.948E−03 | 1.023E−03 | −7.503E−05 |
| 3 | 1.353E−02 | −1.333E−03 | −1.421E−03 | 5.780E−04 | −6.907E−05 |
| 4 | 1.867E−02 | −8.638E−04 | −2.876E−03 | 1.108E−03 | −1.321E−04 |
| 5 | 3.930E−02 | −2.148E−03 | −8.593E−03 | 3.846E−03 | −5.247E−04 |
| 6 | 9.298E−02 | −4.884E−02 | 1.460E−02 | −2.287E−03 | 1.464E−04 |
| 7 | −8.665E−02 | 5.372E−02 | −2.006E−02 | 4.050E−03 | −3.376E−04 |
| 8 | 7.865E−02 | −7.985E−02 | 4.466E−02 | −1.313E−02 | 1.582E−03 |
| 9 | 1.021E−01 | −7.924E−02 | 3.530E−02 | −8.414E−03 | 8.298E−04 |
| 10 | −1.775E−02 | −1.664E−02 | 1.348E−02 | −3.820E−03 | 3.924E−04 |
| 11 | −5.376E−02 | 1.513E−02 | −2.452E−03 | 1.890E−04 | −3.377E−06 |
| 12 | −3.244E−02 | 7.960E−03 | −1.217E−03 | 1.037E−04 | −3.672E−06 |
| 13 | 2.339E−03 | −6.346E−04 | 8.648E−05 | −6.055E−06 | 1.734E−07 |
| 14 | 3.000E−03 | −5.627E−04 | 6.181E−05 | −3.643E−06 | 8.890E−08 |
| 15 | 1.875E−04 | −3.053E−05 | 2.773E−06 | −1.331E−07 | 2.662E−09 |
| 16 | −4.612E−04 | 3.777E−05 | −1.919E−06 | 5.531E−08 | −6.931E−10 |
| 17 | −1.585E−04 | 1.334E−05 | −6.936E−07 | 2.027E−08 | −2.546E−10 |

A value of each conditional expression is described below.

|R1r/R1f|=6.3

f3/f=2.21

f3/f1=2.65

f4/f=−9.98

f4/f=−4.51

f234/f=−4.59

D45/D56=1.8

R6f/R6r=2.2

f2/f6=−0.84

f3/f6=1.03

f7/f=−4.85

f67/f=3.54

R8f/R8r=1.5

f8/f7=0.61

D78/f=0.05

TL/f=1.1

The imaging lens according to Example 12 satisfies the above-described conditional expressions. As shown in FIG. 24, the imaging lens according to Example 12 can also satisfactorily correct aberrations.

Therefore, when the imaging lens according to the above embodiment is applied to imaging optical systems of cameras built in portable information devices, such as smartphones, cellular phones, and portable information terminals, video game consoles, home appliances, automobiles, and the like, it is possible to achieve both greater functionality and miniaturization of the cameras.

The present invention is applicable to an imaging lens assembled into relatively small-sized cameras to be built in portable information devices, such as smartphones, medical devices, video game consoles, home appliances, automobiles, and the like.

### DESCRIPTION OF REFERENCE NUMERALS

X: optical axis
ST: aperture stop
L1: first lens
L2: second lens
L3: third lens
L4: fourth lens
L5: fifth lens
L6: sixth lens
L7: seventh lens
L8: eighth lens
IR: filter
IM: image plane

What is claimed is:

1. An imaging lens for forming an image of an object on an image sensor comprising:
in order from an object side to an image side,
a first lens having positive refractive power;
a second lens having negative refractive power;
a third lens having positive refractive power;
a fourth lens having negative refractive power;
a fifth lens;
a sixth lens;
a seventh lens; and
an eighth lens having negative refractive power,
wherein the eighth lens has an aspheric image-side surface having at least one inflection point, and a conditional expression below is satisfied:
−12.0<f4/f<−3.0
where
f: a focal length of entire optical system of the imaging lens, and
f4: a focal length of the fourth lens.

2. The imaging lens according to claim 1, wherein a conditional expression below is satisfied:
1.0<R6f/R6r<30.0
where
R6f: a curvature radius of an object-side surface of the sixth lens, and
R6r: a curvature radius of an image-side surface of the sixth lens.

3. The imaging lens according to claim 1 or 2, wherein a conditional expression below is satisfied:
−2.50<f2/f6<−0.30
where
f2: a focal length of the second lens, and
f6: a focal length of the sixth lens.

4. The imaging lens according to any one of claims 1 to 3, wherein a conditional expression below is satisfied:
−15.00<f7/f<−3.50
where
f: a focal length of entire optical system of the imaging lens, and
f7: a focal length of the seventh lens.

5. The imaging lens according to any one of claims 1 to 4, wherein a conditional expression below is satisfied:
1.0<R8f/R8r<100.0
where
R8f: a curvature radius of an object-side surface of the eighth lens, and
R8r: a curvature radius of an image-side surface of the eighth lens.
